(19) United States
(12) Patent Application Publication
(10) Pub. No.: US 2025/0302039 A1
(43) Pub. Date: Oct. 2, 2025

(54) USE OF N-SUBSTITUTED PYRROLIDONES TO PROMOTE THE PENETRATION OF AGROCHEMICAL ACTIVE AGENTS

(71) Applicant: Clariant International Ltd., Muttenz (CH)

(72) Inventors: John APONTE, Charlotte, NC (US); Peter BAUR, Schondorf (DE); Gerd SCHWEINITZER, Frankfurt am Main (DE); Robert MILBRADT, Wiesbaden (DE); Roland ARNOLD, Elbtal (DE); Luciana BODELON, Frankfurt am Main (DE); Tanja WEICK, Kelkheim (DE)

(73) Assignee: Clariant International Ltd., Muttenz (CH)

(21) Appl. No.: 19/036,447

(22) Filed: Jan. 24, 2025

Related U.S. Application Data
(63) Continuation of application No. 16/305,914, filed on Nov. 30, 2018, now abandoned.

(30) Foreign Application Priority Data
Jun. 8, 2016 (DE) 102016210164.1

(51) Int. Cl. A01N 43/36; A01N 25/02; A01N 25/04; A01N 33/18; A01N 37/08; A01N 43/40; A01N 43/54; A01N 43/56; A01N 43/58; A01N 43/653; A01N 43/707; A01N 43/78; A01N 43/90; A01N 47/24; A01N 47/36; A01N 47/40

(52) U.S. Cl. CPC A01N 43/36; A01N 25/02; A01N 25/04; A01N 33/18; A01N 37/08; A01N 43/40; A01N 43/54; A01N 43/56; A01N 43/58; A01N 43/653; A01N 43/707; A01N 43/78; A01N 43/90; A01N 47/24; A01N 47/36; A01N 47/40

(57) ABSTRACT

Disclosed herein is a method for promoting the penetration of at least one active agrochemical ingredient into a plant. The method includes the step of contacting the plant with a crop protection composition containing N-(n-butyl)-2-pyrrolidone and the at least one active agrochemical ingredient.

### RELATED APPLICATION DATA

This application is a continuation application of U.S. patent application Ser. No. 16/305,914 filed on Nov. 30, 2018, which is a § 371 National Stage Application of International Patent Application No. PCT/EP2017/062180 filed May 19, 2017, which claims priority to German Patent Application No. 102016210164.1 filed Jun. 8, 2016, the entire contents of each of which are hereby incorporated herein by reference.

The invention relates to the use of particular N-substituted pyrrolidones to promote the penetration of active agrochemical ingredients into plants or into non-plant harmful organisms and to a corresponding method of promoting the penetration of active agrochemical ingredients into plants or into non-plant harmful organisms, and to crop protection compositions comprising particular N-substituted pyrrolidones.

A general problem affecting the application of active agrochemical ingredients is that only a fraction of the active ingredients develops the desired activity. The greater portion is often lost unutilized, in that the active ingredient does not reach the leaves or roots of the plant on deployment, for example, of a spray liquor, but seeps away unutilized in the soil, is not well assimilated at the target plant, is washed away by rain or is simply not properly absorbed by the plant. But another problem may also be that the active agrochemical ingredient does not penetrate in a sufficient amount, if at all, into non-plant harmful organisms that are to be controlled and hence does not display its full efficacy.

For better absorption of active agrochemical ingredients into plants, an important role is played, for example, by substances that promote the penetration of active agrochemical ingredients into the plants. Typical representatives are esterified vegetable oils which increase the penetration rate through the leaf surface, or surfactants and mineral oils which increase the contact area. However, agents with these mechanisms of action are often in need of improvement for reasons such as inadequate plant compatibility, problems with use or stability in formulations or application liquids, inadequate action, excessive application rates or costs. Furthermore, it would be desirable also to provide substances that promote the penetration of active agrochemical ingredients into non-plant harmful organisms.

The problem addressed was thus that of providing substances that are advantageously suitable for promotion of penetration of active agrochemical ingredients into plants or into non-plant harmful organisms.

It has now been found that, surprisingly, this problem is solved, and N-substituted pyrrolidones of the formula (I)

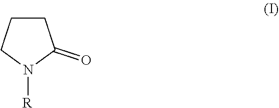

in which
R is a linear or branched, saturated alkyl group having 3 to 6, preferably 3 to 5 and more preferably 4 carbon atoms, where one hydrogen —H in the alkyl group may be replaced by a methoxy group —OCH₃,
and where 1 to 6 hydrogens —H in the pyrrolidone ring may be replaced by methyl —CH₃,
are advantageously suitable for promotion of the penetration of one or more active agrochemical ingredients into plants or into non-plant harmful organisms.

### BRIEF DESCRIPTION OF THE DRAWINGS

FIG. 1 Shows the results of penetration tests with prothioconazole at 10° C. and 20° C. in pear. On the x axis is plotted the time after application in hours (h) and on the y axis is plotted the proportion of active ingredient that has penetrated through the cuticle of the plant, based on the total amount of active ingredient applied to the plant, in percent (%).

FIGS. 2A & 2B show microscopy images (400× magnification) comparing the crystallization behavior of abamectin in different solvent systems after 18 hours of drying. FIG. 2A shows abamectin crystallized out of an acetone/water (30:70) solution. FIG. 2B shows abamectin remaining dissolved in N-(n-butyl)-2-pyrrolidone/water (30:70) solution.

FIGS. 3A & 3B show microscopy images (400× magnification) comparing the crystallization behavior of rynaxypyr in different solvent systems after 18 hours of drying. FIG. 3A shows rynaxypyr crystallized out of an acetone/water (30:70) solution. FIG. 3B shows rynaxypyr remaining dissolved in N-(n-butyl)-2-pyrrolidone/water (30:70) solution.

FIGS. 4A & 4B show microscopy images (400× magnification) comparing the crystallization behavior of emamectin benzoate in different solvent systems after 18 hours of drying. FIG. 4A shows emamectin benzoate crystallized out of an acetone/water (30:70) solution. FIG. 4B shows emamectin benzoate remaining dissolved in N-(n-butyl)-2-pyrrolidone/water (30:70) solution.

The present invention therefore provides for the use of one or more N-substituted pyrrolidones of the formula (I)

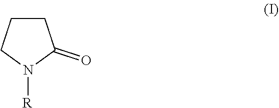

R is a linear or branched, saturated alkyl group having 3 to 6, preferably 3 to 5 and more preferably 4 carbon atoms, where one hydrogen —H in the alkyl group may be replaced by a methoxy group —OCH₃,
and where 1 to 6 hydrogens —H in the pyrrolidone ring may be replaced by methyl —CH₃,
for promotion of the penetration of one or more active agrochemical ingredients into plants or into non-plant harmful organisms.

The one or more N-substituted pyrrolidones of the formula (I) are correspondingly N-substituted 2-pyrrolidones, meaning that the carbonyl group CO of the pyrrolidone ring is adjacent to the ring nitrogen N.

The effect of the N-substituted pyrrolidones of the formula (I) as penetrant increases the biological efficacy of active agrochemical ingredients by enhanced penetration thereof into the plants, for example into the cuticle, or into the non-plant harmful organisms. More particularly, in the presence of one or more N-substituted pyrrolidones of the formula (I), more active agrochemical ingredient is absorbed into the plant or into the non-plant harmful organism compared to the situation where no N-substituted pyrrolidones of the formula (I) are present on employment of the active agrochemical ingredient.

The N-substituted pyrrolidones of the formula (I) feature a very advantageous toxicological and ecological profile. With the aid of the N-substituted pyrrolidones of the formula (I), it is possible to produce crop protection composition formulations without any reproduction-endangering effect and with high biological efficacy.

The N-substituted pyrrolidones of the formula (I) have good dissolving properties and enable a high loading of crop protection compositions with active agrochemical ingredient. It is possible here for the N-substituted pyrrolidones to serve as polar aprotic solvents in particular.

For example, it is possible to use N-(n-butyl)-2-pyrrolidone to prepare solutions of azoxystrobin in an amount of greater than 20% by weight, solutions of tebuconazole in an amount of greater than 50% by weight, solutions of prothioconazole in an amount of greater than 35% by weight, solutions of imidacloprid in an amount of greater than 15% by weight, solutions of metribuzin in an amount of greater than 50% by weight, solutions of saflufenacil in an amount of greater than 20% by weight and solutions of thiacloprid in an amount of greater than 15% by weight, where the amount of active ingredient specified is based in each case on the total weight of the solution.

Owing to the high water solubility of the N-substituted pyrrolidones of the formula (I), these can be used, for example, as the sole liquid phase in crop protection compositions or else combined with water, for example, in water-soluble concentrates (SL).

In addition, the N-substituted pyrrolidones of the formula (I) can also be combined advantageously with various water-immiscible solvents and may serve as cosolvents in solvent-containing formulations, for example in emulsion concentrates (EC), oil dispersions (OD), suspoemulsions (SE) and microemulsions (ME). N-(n-Butyl)-2-pyrrolidone in particular is miscible in all ratios with many solvents, for example with water, propylene glycol, polyethylene glycol, dimethylamide, Solvesso® 200 ND, alkylated vegetable oil or mineral oils.

With the aid of the N-substituted pyrrolidones of the formula (I), it is possible to produce storage-stable crop protection compositions and preferably storage-stable liquid crop protection compositions.

WO 2013/107822 discloses the use of N-substituted pyrrolidones as “non-reprotoxic” solvents, i.e. solvents with no reproduction-endangering effect. WO 2013/107822 also states that the solvents can be used in agrochemical formulations as solvents, diluents or dispersants.

WO 2005/104844 describes the use of carboxamides of the formula R¹—CO—NR²R³ in which R¹ is C₃-C₁₉-alkyl, R² is C₁-C₆ alkyl and R³ is H or C₁-C₆-alkyl for promoting the penetration of active agrochemical ingredients into plants. These carboxamides are acyclic compounds.

EP 0 453 915 A1 discloses the use of N-alkyllactams substituted on the nitrogen N of the ring by an alkyl group having 6 to 18 carbon atoms for prevention of crystallization especially of particular azole derivative active ingredients on deployment of aqueous spray liquors. The N-alkyllactams may, for example, be the corresponding N-alkylpyrrolidones.

In a particularly preferred embodiment of the invention, the one or more N-substituted pyrrolidones of the formula (I) are used to promote the penetration of one or more active agrochemical ingredients into plants.

In a further particularly preferred embodiment of the invention, the one or more N-substituted pyrrolidones of the formula (I) are used to promote the penetration of one or more active agrochemical ingredients into non-plant harmful organisms.

In a further particularly preferred embodiment of the invention, the one or more N-substituted pyrrolidones of the formula (I) are used both to promote the penetration of one or more active agrochemical ingredients into plants and to promote the penetration of one or more active agrochemical ingredients into non-plant harmful organisms. This may be the case particularly when the non-plant harmful organisms have colonized the plant which has been treated with the one or more N-substituted pyrrolidone(s) of the formula (I) and the one or more active agrochemical ingredients, and hence likewise come into contact with these substances. The promotion of penetration into the plant on the one hand and into the non-plant harmful organism on the other hand can take place either simultaneously or successively, for example depending on whether the non-plant harmful organism had already colonized the plant when it was treated with the one or more N-substituted pyrrolidones of the formula (I) and the one or more active agrochemical ingredients or colonized the plant only thereafter.

Preferably, the one or more N-substituted pyrrolidones of the formula (I) are selected from the group consisting of N-(n-butyl)-2-pyrrolidone, N-(isobutyl)-2-pyrrolidone, N-(tert-butyl)-2-pyrrolidone, N-(n-pentyl)-2-pyrrolidone, N-(methyl-substituted butyl)-2-pyrrolidone, ring methyl-substituted N-(propyl)-2-pyrrolidone, ring methyl-substituted N-(butyl)-2-pyrrolidone and N-(methoxypropyl)-2-pyrrolidone.

The N-substituted pyrrolidones of the formula (I) used in accordance with the invention include compounds in which 1 to 6 hydrogens —H in the pyrrolidone ring may be replaced by methyl —CH₃. In the context of the present application, these compounds are also referred to as “ring methyl-substituted N-substituted pyrrolidones” of the formula (I). The ring methyl substitution may be present at position 3, 4 or 5 of the pyrrolidone ring. The ring methyl substitution may be a substitution of the ring by a methyl group. But it also includes, for example, ring dimethyl substitutions, preferably at two different positions in the pyrrolidone ring, for example at positions 3 and 4, 3 and 5 or 4 and 5 of the pyrrolidone ring. Ring methyl substitution additionally includes ring trimethyl substitutions, preferably trimethyl substitution at positions 3, 4 and 5 of the pyrrolidone ring of the ring methyl-substituted N-substituted pyrrolidones of the formula (I).

Among the ring methyl-substituted N-substituted pyrrolidones of the formula (I), the various ring methyl-substituted N-(propyl)-2-pyrrolidones and ring methyl-substituted N-(butyl)-2-pyrrolidones of the formula (I) are preferred, the ring methyl-substituted N-(n-propyl)-, N-(isopropyl)-, N-(n-butyl)-, N-(isobutyl)-, N-(tert-butyl)-, N-(sec-butyl)- and N-(1-methylpropyl)-2-pyrrolidones of the formula (I) are particularly preferred, and the ring methyl-substituted N-(n-butyl)-2-pyrrolidones of the formula (I) are especially preferred.

Preferably, in the one or more N-substituted pyrrolidones of the formula (I), no hydrogen —H in the pyrrolidone ring is replaced by methyl —CH₃.

Further preferably, in the alkyl group of the R radical of the one or more N-substituted pyrrolidones of the formula (I), no hydrogen —H is replaced by a methoxy group —OCH₃.

More preferably, the N-substituted pyrrolidone of the formula (I) is N-(n-butyl)-2-pyrrolidone.

The N-substituted pyrrolidones of the formula (I) are used in accordance with the invention individually or in the form of mixtures.

The N-substituted pyrrolidones of the formula (I) are either commercially available or synthesizable by methods familiar to the person skilled in the art.

In a preferred embodiment of the invention, the one or more N-substituted pyrrolidones of the formula (I), in the use of the invention, are used in a crop protection composition comprising
a) 1% to 90% by weight and preferably 5% to 70% by weight of one or more N-substituted pyrrolidones of the formula (I) and
b) 1% to 90% by weight and preferably 2.5% to 70% by weight of one or more active agrochemical ingredients.

The crop protection compositions just mentioned and those used in the case of use of the invention may contain one or more additives. They contain preferably 0% to 98% by weight and more preferably 1% to 60% by weight of one or more additives.

In a further preferred embodiment of the invention, the one or more N-substituted pyrrolidones of the formula (I), in the use of the invention, are used in a crop protection composition comprising
a) 1% to 50% by weight, preferably 5% to 40% by weight and more preferably 5% to 30% by weight of one or more N-substituted pyrrolidones of the formula (I) and
b) 1% to 90% by weight, preferably 5% to 60% by weight and more preferably 2.5% to 50% by weight of one or more active agrochemical ingredients.

The crop protection compositions just mentioned and those used in the case of use of the invention may contain one or more additives. They contain preferably 0% to 98% by weight and more preferably 1% to 50% by weight of one or more additives.

In a preferred embodiment of the invention, the crop protection compositions used in the case of use of the invention contain water.

The one or more N-substituted pyrrolidones of the formula (I) may, in the use of the invention, also be employed in a tankmix additive, meaning that they are not an integrated constituent of the crop protection composition. Instead, inter alia, the one or more active agrochemical ingredients on the one hand and the N-substituted pyrrolidones of the formula (I) on the other hand are in separate form. The two components are mixed with one another prior to the deployment, generally shortly beforehand. Prior to the deployment, it is also possible to add further components, for example optionally one or more additives and/or water. In principle, this gives rise to a crop protection composition comprising one or more active agrochemical ingredients, one or more N-substituted pyrrolidones of the formula (I), and optionally one or more additives and/or water, albeit only briefly.

In a further preferred embodiment of the invention, the one or more N-substituted pyrrolidones of the formula (I), in the use of the invention, are used in a tankmix additive containing 1% to 90% by weight, preferably 5% to 50% by weight and more preferably 5% to 20% by weight of one or more N-substituted pyrrolidones of the formula (I), and additionally one or more additives and optionally water. The amount of the one or more additives in the tankmix additive is preferably 5% to 95% by weight, more preferably 10% to 90% by weight and especially preferably 20% to 80% by weight.

The respective area- and/or object-based application rate of the crop protection compositions of a wide variety of different formulation types for use for the use of the invention is subject to very significant variation. In general, for this purpose, the application media known to the person skilled in the art to be standard for the respective field of use are used in the standard amounts, for example from fifty to several hundred liters of water per hectare in standard spraying methods through a few liters of oil per hectare in “ultralow volume” aircraft application up to a few milliliters of a physiological solution in injection methods. The concentrations of the crop protection compositions in the respective application media therefore vary within a wide range and are dependent on the respective field of use. In general, concentrations that are known to the person skilled in the art to be standard for the respective field of use are used.

The crop protection compositions may be deployed, for example, in the formulation forms customary for liquid preparations either as they are or after prior dilution with water, i.e., for example, as emulsions, suspensions or solutions. Application is effected by customary methods, i.e., for example, by spraying, pouring or injecting.

The application rate of the crop protection compositions can be varied within a relatively wide range. It is guided by the respective active agrochemical ingredients and by the content thereof in the formulations.

In a further preferred embodiment of the invention, the one or more N-substituted pyrrolidones of the formula (I), in the use of the invention, are used in a crop protection composition in the form of an aqueous spray liquor. These aqueous spray liquors preferably contain
a) 0.001% to 99% by weight, more preferably 0.01% to 50% by weight and especially preferably 0.02% to 1% by weight of one or more N-substituted pyrrolidones of the formula (I) and
b) 0.001% to 10% by weight, more preferably 0.002% to 5% by weight and especially preferably 0.0025% to 3% by weight of one or more active agrochemical ingredients.

The aqueous spray liquors just mentioned and those used in the case of use of the invention may contain one or more additives. They contain preferably 0% to 99% by weight and more preferably 0.01% to 80% by weight of one or more additives.

The stated amounts relating to the N-substituted pyrrolidones of the formula (I), the active agrochemical ingredients and the additives are based on the total weight of the crop protection compositions used in the case of use of the invention and, in the case of active agrochemical ingredients that are acids in protonated form but are used in the form of their water-soluble salts, on the amount of free acid, called the acid equivalent (a.e.).

In the context of the present description, active agrochemical ingredients are understood to mean all active ingredients having biological efficacy that can be increased by enhanced penetration into a crop plant or harmful plant or into a non-plant harmful organism.

Preferred active agrochemical ingredients are selected from pesticides. Pesticides, the majority of which are herbicides, are chemical substances, synthetically produced or of natural origin, that penetrate into plant cells or plant tissue or into parasitic organisms or non-plant harmful organisms in or on the plant and damage and/or destroy them. Preferred pesticides are selected from the group consisting of fungicides, bactericides, insecticides, acaricides, nematicides, herbicides, plant growth regulators, plant nutrients, repellents, molluscicides and rodenticides. Particularly preferred pesticides are selected from the group consisting of herbicides, fungicides and insecticides.

### Examples of Herbicides Include:

Active ingredients based on inhibition of, for example, acetolactate synthase, acetyl-CoA carboxylase, cellulose synthase, enolpyruvylshikimate-3-phosphate synthase, glutamine synthetase, p-hydroxyphenylpyruvate dioxygenase, phytoendesaturase, photosystem I, photosystem II, protoporphyrinogen oxidase, as described, for example, in Weed Research 26 (1986) 441-445 or “The Pesticide Manual”, 16th edition, The British Crop Protection Council and the Royal Soc. of Chemistry, 2012 and literature cited therein. Examples of known herbicides or plant growth regulators include the active ingredients which follow (the compounds are designated by the “common name” according to the International Organization for Standardization (ISO) or by the chemical name or by the code number) and always encompass all use forms, such as acids, salts, esters and isomers, such as stereoisomers and optical isomers. This list includes, by way of example, one use form and in some cases also a plurality of use forms:
acetochlor, acibenzolar, acibenzolar-S-methyl, acifluorfen, acifluorfen-sodium, aclonifen, alachlor, allidochlor, alloxydim, alloxydim-sodium, ametryne, amicarbazone, amidochlor, amidosulfuron, aminocyclopyrachlor, aminocyclopyrachlor-potassium, aminocyclopyrachlor-methyl, aminopyralid, amitrole, ammonium sulfamate, ancymidol, anilofos, asulam, atrazine, aviglycine, azafenidin, azimsulfuron, aziprotryne, beflubutamid, benazolin, benazolin-ethyl, bencarbazone, benfluralin, benfuresate, bensulide, bensulfuron, bensulfuron-methyl, bentazone, benzfendizone, benzobicyclon, benzofenap, benzofluor, benzoylprop, benzyladenine, bicyclopyrone, bifenox, bilanafos, bilanafos-sodium, bispyribac, bispyribac-sodium, bromacil, bromobutide, bromofenoxim, bromoxynil, bromuron, buminafos, busoxinone, butachlor, butafenacil, butamifos, butenachlor, butralin, butroxydim, butylate, cafenstrole, carbaryl, carbetamide, carfentrazone, carfentrazone-ethyl, carvone, chlorocholine chloride, chlomethoxyfen, chloramben, chlorazifop, chlorazifop-butyl, chlorbromuron, chlorbufam, chlorfenac, chlorfenac-sodium, chlorfenprop, chlorflurenol, chlorflurenol-methyl, chloridazon, chlorimuron, chlorimuron-ethyl, chlormequat-chloride, chlornitrofen, 4-chlorophenoxyacetic acid, chlorophthalim, chlorpropham, chlorthal-dimethyl, chlortoluron, chlorsulfuron, cinidon, cinidon-ethyl, cinmethylin, cinosulfuron, clethodim, clodinafop, clodinafop-propargyl, clofencet, clomazone, clomeprop, cloprop, clopyralid, cloransulam, cloransulam-methyl, cloxyfonac, cumyluron, cyanamide, cyanazine, cyclanilide, cycloate, cyclosulfamuron, cycloxydim, cycluron, cyhalofop, cyhalofop-butyl, cyperquat, cyprazine, cyprazole, cytokinine, 2,4-D, 2,4-DB, daimuron/dymron, dalapon, daminozide, dazomet, n-decanol, desmedipham, desmetryn, detosyl-pyrazolate (DTP), diallate, diaminozide, dicamba, dichlobenil, dichlorprop, dichlorprop-P, diclofop, diclofop-methyl, diclofop-P-methyl, diclosulam, diethatyl, diethatyl-ethyl, difenoxuron, difenzoquat, diflufenican, diflufenzopyr, diflufenzopyr-sodium, dikegulac-sodium, dimefuron, dimepiperate, dimethachlor, dimethametryn, dimethenamid, dimethenamid-P, dimethipin, dimetrasulfuron, dinitramine, dinoseb, dinoterb, diphenamid, diisopropylnaphthalene, dipropetryn, diquat, diquat-dibromide, dithiopyr, diuron, DNOC, eglinazine-ethyl, endothal, EPTC, esprocarb, ethalfluralin, ethametsulfuron, ethametsulfuron-methyl, ethyl naphthylacetate, ethephon, ethidimuron, ethiozin, ethofumesate, ethoxyfen, ethoxyfen-ethyl, ethoxysulfuron, etobenzanid, F-5331, i.e. N-[2-chloro-4-fluoro-5-[4-(3-fluoropropyl)-4,5-dihydro-5-oxo-1H-tetrazol-1-yl]phenyl]ethanesulfonamide, F-7967, i.e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoprop, fenoxaprop, fenoxaprop-P, fenoxaprop-ethyl, fenoxaprop-P-ethyl, fenoxasulfone, fentrazamide, fenuron, flamprop, flamprop-M-isopropyl, flamprop-M-methyl, flazasulfuron, florasulam, fluazifop, fluazifop-P, fluazifop-butyl, fluazifop-P-butyl, fluazolate, flucarbazone, flucarbazone-sodium, flucetosulfuron, fluchloralin, flufenacet (thiafluamide), flufenpyr, flufenpyr-ethyl, flumetralin, flumetsulam, flumiclorac, flumiclorac-pentyl, flumioxazin, flumipropyn, fluometuron, fluorodifen, fluoroglycofen, fluoroglycofen-ethyl, flupoxam, flupropacil, flupropanate, flupyrsulfuron, flupyrsulfuron-methyl-sodium, flurenol, flurenol-butyl, fluridone, flurochloridone, fluroxypyr, fluroxypyr-meptyl, flurprimidol, flurtamone, fluthiacet, fluthiacet-methyl, fluthiamide, fomesafen, foramsulfuron, forchlorfenuron, fosamine, furyloxyfen, gibberellic acid, glufosinate, glufosinate-ammonium, glufosinate-P, glufosinate-P-ammonium, glufosinate-P-sodium, glyphosate, glyphosate-isopropylammonium, H-9201, i.e. O-(2,4-dimethyl-6-nitrophenyl)O-ethyl isopropylphosphoramidothioate, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl)ethyl (2,4-dichlorophenoxy)acetate, imazamethabenz, imazamethabenz-methyl, imazamox, imazamox-ammonium, imazapic, imazapyr, imazapyr-isopropylammonium, imazaquin, imazaquin-ammonium, imazethapyr, imazethapyr-ammonium, imazosulfuron, inabenfide, indanofan, indaziflam, indoleacetic acid (IAA), 4-indol-3-ylbutyric acid (IBA), iodosulfuron, iodosulfuron-methyl-sodium, iofensulfuron, iofensulfuron-sodium, ioxynil, ipfencarbazone, isocarbamid, isopropalin, isoproturon, isouron, isoxaben, isoxachlortole, isoxaflutole, isoxapyrifop, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, karbutilate, ketospiradox, lactofen, lenacil, linuron, maleic hydrazide, MCPA, MCPB, MCPB-methyl, -ethyl and -sodium, mecoprop, mecoprop-sodium, mecoprop-butotyl, mecoprop-P-butotyl, mecoprop-P-dimethylammonium, mecoprop-P-2-ethylhexyl, mecoprop-P-potassium, mefenacet, mefluidide, mepiquat-chloride, mesosulfuron, mesosulfuron-methyl, mesotrione, methabenzthiazuron, metam, metamifop, metamitron, metazachlor, metazasulfuron, methazole, methiopyrsulfuron, methiozolin, methoxyphenone, methyldymron, 1-methylcyclopropene, methyl isothiocyanate, metobenzuron, metobromuron, metolachlor, S-metolachlor, metosulam, metoxuron, metribuzin, metsulfuron, metsulfuron-methyl, molinate, monalide, monocarbamide, monocarbamide dihydrogensulfate, monolinuron, monosulfuron, monosulfuron ester, monuron, MT-128, i.e. 6-chloro-N-[(2E)-3-chloroprop-2-en-1-yl]-5-methyl-N-phenylpyridazin-3-amine, MT-5950, i.e. N-[3-chloro-4-(1-methylethyl)phenyl]-2-methylpentanamide, NGGC-011, 1-naphthylacetic acid (NAA), naphthylacetamide (NAAm), 2-naphthoxyacetic acid, naproanilide, napropamide, naptalam, NC-310, i.e. 4-(2,4-dichlorobenzoyl)-1-methyl-5-benzyloxypyrazole, neburon, nicosulfuron, nipyraclofen, nitralin, nitrofen, nitroguaiacolate, nitrophenolate-sodium (isomer mixture), nitrofluorfen, nonanoic acid, norflurazon, orbencarb, orthosulfamuron, oryzalin, oxadiargyl, oxadiazon, oxasulfuron, oxaziclomefone, oxyfluorfen, paclobutrazole, paraquat, paraquat dichloride, pelargonic acid (nonanoic acid), pendimethalin, pendralin, penoxsulam, pentanochlor, pentoxazone, perfluidone, pethoxamid, phenisopham, phenmedipham, phenmedipham-ethyl, picloram, picolinafen, pinoxaden, piperophos, pirifenop, pirifenop-butyl, pretilachlor, primisulfuron, primisulfuron-methyl, probenazole, profluazole, procyazine, prodiamine, prifluraline, profoxydim, prohexadione, prohexadione-calcium, prohydrojasmone, prometon, prometryn, propachlor, propanil, propaquizafop, propazine, propham, propisochlor, propoxycarbazone, propoxycarbazone-sodium, propyrisulfuron, propyzamide, prosulfalin, prosulfocarb, prosulfuron, prynachlor, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, secbumeton, sethoxydim, siduron, simazine, simetryn, SN-106279, i.e. methyl (2R)-2-({7-[2-chloro-4-(trifluoromethyl)phenoxy]-2-naphthyl}oxy)propanoate, sulcotrione, sulfallate (CDEC), sulfentrazone, sulfometuron, sulfometuron-methyl, sulfosate (glyphosate-trimesium), sulfosulfuron, SW-065, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, tebutam, tebuthiuron, tecnazene, tefuryltrione, tembotrione, tepraloxydim, terbacil, terbucarb, terbuchlor, terbumeton, terbuthylazine, terbutryne, thenylchlor, thiafluamide, thiazafluron, thiazopyr, thidiazimin, thidiazuron, thiencarbazone, thiencarbazone-methyl, thifensulfuron, thifensulfuron-methyl, thiobencarb, tiocarbazil, topramezone, tralkoxydim, triafamone, triallate, triasulfuron, triaziflam, triazofenamide, tribenuron, tribenuron-methyl, tribufos, trichloroacetic acid (TCA), triclopyr, tridiphane, trietazine, trifloxysulfuron, trifloxysulfuron-sodium, trifluralin, triflusulfuron, triflusulfuron-methyl, trimeturon, trinexapac, trinexapac-ethyl, tritosulfuron, tsitodef, uniconazole, uniconazole-P, vernolate, ZJ-0862, i.e. 3,4-dichloro-N-{2-[(4,6-dimethoxypyrimidin-2-yl)oxy]benzyl}aniline, and the following compounds:

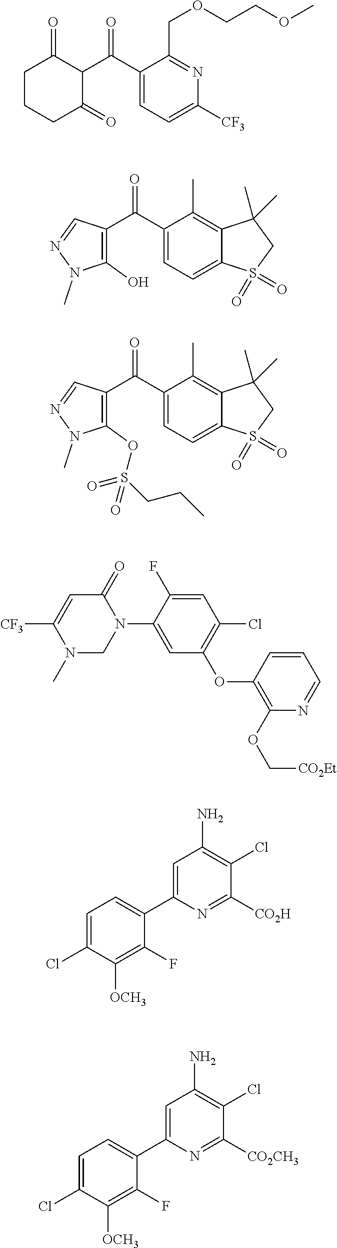 [SMILES: COCCOCc1nc(C(F)(F)F)ccc1C(=O)C1C(=O)CCCC1=O ; Cc1c(C(=O)c2cnn(C)c2O)ccc2c1C(C)(C)CS2(=O)=O ; CCCS(=O)(=O)Oc1c(C(=O)c2ccc3c(c2C)C(C)(C)CS3(=O)=O)cnn1C ; CCOC(=O)COc1ncccc1Oc1cc(N2CN(C)C(C(F)(F)F)=CC2=O)c(F)cc1Cl ; COc1c(Cl)ccc(-c2cc(N)c(Cl)c(C(=O)O)n2)c1F ; COC(=O)c1nc(-c2ccc(Cl)c(OC)c2F)cc(N)c1Cl]

Examples of plant growth regulators include the following: abscisic acid, amidochlor, ancymidol, 6-benzylaminopurine, brassinolide, brassinosteroids, butralin, chlormequat (chlormequat chloride), choline chloride, cyclanilide, daminozide, dikegulac, dimethipin, 2,6-dimethylpyridine, ethephon, flumetralin, flurprimidol, fluthiacet, forchlorfenuron, gibberellic acid, inabenfid, indole-3-acetic acid, jasmonic acid, kinetin, maleic hydrazide, mefluidide, mepiquat (mepiquat chloride), 1-naphthylacetic acid, N-6-benzyladenine, paclobutrazole, prohexadione (prohexadione-calcium), prohydrojasmon, salicylic acid and its esters, thidiazuron, triapenthenol, tributyl phosphorotrithioate, 2,3,5-triiodobenzoic acid, trinexapac-ethyl and uniconazole.

Further substances that should be mentioned are those which can act as plant growth regulators and/or plant fortifiers, in order to reduce the effect of stress factors such as heat, cold, drought, salt, oxygen deficiency or flooding on plant growth. Examples of these include glycine betaine (betaine), choline, potassium phosphate or other phosphate salts, and silicates.

Examples of plant nutrients include customary inorganic or organic fertilizers for supplying plants with macro- and/or micronutrients.

### Examples of Fungicides Include:

(1) Ergosterol biosynthesis inhibitors, for example aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulfate, imibenconazole, ipconazole, metconazole, myclobutanil, naftifin, nuarimol, oxpoconazole, paclobutrazole, pefurazoate, penconazole, piperalin, prochloraz, propiconazole, prothioconazole, pyributicarb, pyrifenox, quinconazole, simeconazole, spiroxamine, tebuconazole, terbinafine, tetraconazole, triadimefon, triadimenol, tridemorph, triflumizole, triforine, triticonazole, uniconazole, uniconazole-p, viniconazole, voriconazole, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N′-{5-(difluoromethyl)-2-methyl-4-[3-(trimethylsilyl)propoxy]phenyl}-N-ethyl-N-methylimidoformamide, N-ethyl-N-methyl-N′-{2-methyl-5-(trifluoromethyl)-4-[3-(trimethylsilyl)propoxy]phenyl}imidoformamide and O-[1-(4-methoxyphenoxy)-3,3-dimethylbutan-2-yl]1H-imidazole-1-carbothioate.

(2) Respiration inhibitors (respiratory chain inhibitors), for example bixafen, boscalid, carboxin, diflumetorim, fenfuram, fluopyram, flutolanil, fenpicoxamid, fluxapyroxad, furametpyr, furmecyclox, isopyrazam mixture of the syn-epimeric racemate 1RS,4SR,9RS and of the anti-epimeric racemate 1RS,4SR,9SR, isopyrazam (anti-epimeric racemate), isopyrazam (anti-epimeric enantiomer 1R,4S,9S), isopyrazam (anti-epimeric enantiomer 1S,4R,9R), isopyrazam (syn-epimeric racemate 1RS,4SR,9RS), isopyrazam (syn-epimeric enantiomer 1R,4S,9R), isopyrazam (syn-epimeric enantiomer 1S,4R,9S), mepronil, oxycarboxin, penflufen, penthiopyrad, sedaxane, thifluzamid, 1-methyl-N-[2-(1,1,2,2-tetrafluoroethoxy)phenyl]-3-(trifluoromethyl)-1H-pyrazole-4-carboxamide, 3-(difluoromethyl)-1-methyl-N-[2-(1,1,2,2-tetrafluoroethoxy)phenyl]-1H-pyrazole-4-carboxamide, 3-(difluoromethyl)-N-[4-fluoro-2-(1,1,2,3,3,3-hexafluoropropoxy)phenyl]-1-methyl-1H-pyrazole-4-carboxamide, N-[1-(2,4-dichlorophenyl)-1-methoxypropan-2-yl]-3-(difluoromethyl)-1-methyl-1H-pyrazole-4-carboxamide, 5,8-difluoro-N-[2-(2-fluoro-4-{[4-(trifluoromethyl)pyridin-2-yl]oxy}phenyl)ethyl]quinazolin-4-amine, N-[9-(dichloromethylene)-1,2,3,4-tetrahydro-1,4-methanonaphthalen-5-yl]-3-(difluoromethyl)-1-methyl-1H-pyrazole-4-carboxamide, N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide and N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide.

(3) Respiration inhibitors (respiratory chain inhibitors) acting on complex III of the respiratory chain, for example ametoctradin, amisulbrom, azoxystrobin, cyazofamid, coumethoxystrobin, coumoxystrobin, dimoxystrobin, enestroburin, famoxadone, fenamidone, fenoxystrobin, fluoxastrobin, kresoxim-methyl, metominostrobin, orysastrobin, picoxystrobin, pyraclostrobin, pyrametostrobin, pyraoxystrobin, pyribencarb, triclopyricarb, trifloxystrobin, (2E)-2-(2-{[6-(3-chloro-2-methylphenoxy)-5-fluoropyrimidin-4-yl]oxy}phenyl)-2-(methoxyimino)-N-methylethanamide, (2E)-2-(methoxyimino)-N-methyl-2-(2-{[({(1E)-1-[3-(trifluoromethyl)phenyl]ethylidene}amino)oxy]methyl}phenyl)ethanamide, (2E)-2-(methoxyimino)-N-methyl-2-{2-[(E)-({1-[3-(trifluoromethyl)phenyl]ethoxy}imino)methyl]phenyl}ethanamide, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, (2E)-2-{2-[({[(2E,3E)-4-(2,6-dichlorophenyl)but-3-en-2-ylidene]amino}oxy)methyl]phenyl}-2-(methoxyimino)-N-methylethanamide, 2-chloro-N-(1,1,3-trimethyl-2,3-dihydro-1H-inden-4-yl)pyridine-3-carboxamide, 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, methyl (2E)-2-{2-[({cyclopropyl[(4-methoxyphenyl)imino]methyl}sulfanyl)methyl]phenyl}-3-methoxyprop-2-enoate, N-(3-ethyl-3,5,5-trimethylcyclohexyl)-3-(formylamino)-2-hydroxybenzamide, 2-{2-[(2,5-dimethylphenoxy)methyl]phenyl}-2-methoxy-N-methylacetamide and (2R)-2-{2-[(2,5-dimethylphenoxy)methyl]phenyl}-2-methoxy-N-methylacetamide.

(4) Mitosis and cell division inhibitors, for example benomyl, carbendazim, chlorfenazole, diethofencarb, ethaboxam, fluopicolide, fuberidazole, pencycuron, thiabendazole, thiophanate-methyl, thiophanate, zoxamide, 5-chloro-7-(4-methylpiperidin-1-yl)-6-(2,4,6-trifluorophenyl)[1,2,4]triazolo[1,5-a]pyrimidine and 3-chloro-5-(6-chloropyridin-3-yl)-6-methyl-4-(2,4,6-trifluorophenyl)pyridazine.

(5) Compounds with multisite activity, for example Bordeaux mixture, captafol, captan, chlorothalonil, copper preparations such as copper hydroxide, copper naphthenate, copper oxide, copper oxychloride, copper sulfate, dichlofluanid, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram zinc, oxine-copper, propamidine, propineb, sulfur and sulfur preparations, for example calcium polysulfide, thiram, tolylfluanid, zineb and ziram.

(6) Resistance inductors, for example acibenzolar-S-methyl, isotianil, probenazole and tiadinil.

(7) Amino acid and protein biosynthesis inhibitors, for example andoprim, blasticidin-S, cyprodinil, kasugamycin, kasugamycin hydrochloride hydrate, mepanipyrim, pyrimethanil and 3-(5-fluoro-3,3,4,4-tetramethyl-3,4-dihydroisoquinolin-1-yl)quinoline.

(8) Inhibitors of ATP production, for example fentin acetate, fentin chloride, fentin hydroxide and silthiofam.

(9) Cell wall synthesis inhibitors, for example benthiavalicarb, dimethomorph, flumorph, iprovalicarb, mandipropamid, polyoxins, polyoxorim, validamycin A and valifenalate.

(10) Lipid and membrane synthesis inhibitors, for example biphenyl, chloroneb, dicloran, edifenphos, etridiazole, iodocarb, iprobenfos, isoprothiolane, propamocarb, propamocarb hydrochloride, prothiocarb, pyrazophos, quintozene, tecnazene and tolclofos-methyl.

(11) Melanin biosynthesis inhibitors, for example carpropamid, diclocymet, fenoxanil, fthalide, pyroquilon, tricyclazole and 2,2,2-trifluoroethyl {3-methyl-1-[(4-methylbenzoyl)amino]butan-2-yl}carbamate.

(12) Nucleic acid synthesis inhibitors, for example benalaxyl, benalaxyl-M (kiralaxyl), bupirimate, clozylacon, dimethirimol, ethirimol, furalaxyl, hymexazol, metalaxyl, metalaxyl-M (mefenoxam), ofurace, oxadixyl and oxolinic acid.

(13) Signal transduction inhibitors, for example chlozolinate, fenpiclonil, fludioxonil, iprodione, procymidone, quinoxyfen and vinclozolin.

(14) Decouplers, for example binapacryl, dinocap, ferimzone, fluazinam and meptyldinocap.

(15) Further compounds, for example benthiazole, bethoxazin, capsimycin, carvone, chinomethionat, pyriofenone (chlazafenone), cufraneb, cyflufenamid, cymoxanil, cyprosulfamide, dazomet, debacarb, dichlorophen, diclomezine, difenzoquat, difenzoquat methylsulfate, diphenylamine, ecomat, fenpyrazamine, flumetover, fluoromide, flusulfamide, flutianil, fosetyl-aluminum, fosetyl-calcium, fosetyl-sodium, hexachlorobenzene, irumamycin, methasulfocarb, methyl isothiocyanate, metrafenon, mildiomycin, natamycin, nickel dimethyldithiocarbamate, nitrothal-isopropyl, octhilinone, oxamocarb, oxyfenthiin, pentachlorophenol and salts thereof, phenothrin, phosphoric acid and salts thereof, propamocarb-fosetylate, propanosine-sodium, proquinazid, pyrimorph, (2E)-3-(4-tert-butylphenyl)-3-(2-chloropyridin-4-yl)-1-(morpholin-4-yl)prop-2-en-1-one, (2Z)-3-(4-tert-butylphenyl)-3-(2-chloropyridin-4-yl)-1-(morpholin-4-yl)prop-2-en-1-one, pyrrolnitrin, tebufloquin, tecloftalam, tolnifanid, triazoxide, trichlamide, zarilamide, (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-methoxyphenoxy)-3,3-dimethylbutan-2-yl 1H-imidazole-1-carboxylate, 2,3,5,6-tetrachloro-4-(methylsulfonyl)pyridine, 2,3-dibutyl-6-chlorothieno[2,3-d]pyrimidin-4(3H)-one, 2,6-dimethyl-1H,5H-[1,4]dithiino[2,3-c:5,6-c′]dipyrrole-1,3,5,7(2H,6H)-tetrone, 2-[5-methyl-3-(trifluoromethyl)-1H-pyrazol-1-yl]-1-(4-{4-[(5R)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-(4-{4-[(5S)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-{4-[4-(5-phenyl-4,5-dihydro-1,2-oxazol-3-yl)-1,3-thiazol-2-yl]piperidin-1-yl}ethanone, 2-butoxy-6-iodo-3-propyl-4H-chromen-4-one, 2-chloro-5-[2-chloro-1-(2,6-difluoro-4-methoxyphenyl)-4-methyl-1H-imidazol-5-yl]pyridine, 2-phenylphenol and salts thereof, 3-(4,4,5-trifluoro-3,3-dimethyl-3,4-dihydroisoquinolin-1-yl)quinoline, 3,4,5-trichloropyridine-2,6-dicarbonitrile, 3-[5-(4-chlorophenyl)-2,3-dimethyl-1,2-oxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, 5-amino-1,3,4-thiadiazole-2-thiol, 5-chloro-N′-phenyl-N′-(prop-2-yn-1-yl)thiophene-2-sulfonohydrazide, 5-fluoro-2-[(4-fluorobenzyl)oxy]pyrimidin-4-amine, 5-fluoro-2-[(4-methylbenzyl)oxy]pyrimidin-4-amine, 5-methyl-6-octyl[1,2,4]triazolo[1,5-a]pyrimidin-7-amine, ethyl (2Z)-3-amino-2-cyano-3-phenylprop-2-enoate, N′-(4-{[3-(4-chlorobenzyl)-1,2,4-thiadiazol-5-yl]oxy}-2,5-dimethylphenyl)-N-ethyl-N-methylimidoformamide, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(E)-[(cyclopropylmethoxy)imino][6-(difluoromethoxy)-2,3-difluorophenyl]methyl}-2-phenylacetamide, N—{(Z)-[(cyclopropylmethoxy)imino][6-(difluoromethoxy)-2,3-difluorophenyl]methyl}-2-phenylacetamide, N′-{4-[(3-tert-butyl-4-cyano-1,2-thiazol-5-yl)oxy]-2-chloro-5-methylphenyl}-N-ethyl-N-methylimidoformamide, N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, N-methyl-2-(1-{[5-methyl-3-(trifluoromethyl)-1H-pyrazol-1-yl]acetyl}piperidin-4-yl)-N-[(1R)-1,2,3,4-tetrahydronaphthalen-1-yl]-1,3-thiazole-4-carboxamide, N-methyl-2-(1-{[5-methyl-3-(trifluoromethyl)-1H-pyrazol-1-yl]acetyl}piperidin-4-yl)-N-[(1S)-1,2,3,4-tetrahydronaphthalen-1-yl]-1,3-thiazole-4-carboxamide, pentyl {6-[({[(1-methyl-1H-tetrazol-5-yl)(phenyl)methylidene]amino}oxy)methyl]pyridin-2-yl}carbamate, phenazine-1-carboxylic acid, quinolin-8-ol, quinolin-8-ol sulfate (2:1) and tert-butyl {6-[({[(1-methyl-1H-tetrazol-5-yl)(phenyl)methylene]amino}oxy)methyl]pyridin-2-yl}carbamate.

(16) Further compounds, for example 1-methyl-3-(trifluoromethyl)-N-[2′-(trifluoromethyl)biphenyl-2-yl]-1H-pyrazole-4-carboxamide, N-(4′-chlorobiphenyl-2-yl)-3-(difluoromethyl)-1-methyl-1H-pyrazole-4-carboxamide, N-(2′,4′-dichlorobiphenyl-2-yl)-3-(difluoromethyl)-1-methyl-1H-pyrazole-4-carboxamide, 3-(difluoromethyl)-1-methyl-N-[4′-(trifluoromethyl)biphenyl-2-yl]-1H-pyrazole-4-carboxamide, N-(2′,5′-difluorobiphenyl-2-yl)-1-methyl-3-(trifluoromethyl)-1H-pyrazole-4-carboxamide, 3-(difluoromethyl)-1-methyl-N-[4′-(prop-1-yn-1-yl)biphenyl-2-yl]-1H-pyrazole-4-carboxamide, 5-fluoro-1,3-dimethyl-N-[4′-(prop-1-yn-1-yl)biphenyl-2-yl]-1H-pyrazole-4-carboxamide, 2-chloro-N-[4′-(prop-1-yn-1-yl)biphenyl-2-yl]pyridine-3-carboxamide, 3-(difluoromethyl)-N-[4′-(3,3-dimethylbut-1-yn-1-yl)biphenyl-2-yl]-1-methyl-1H-pyrazole-4-carboxamide, N-[4′-(3,3-dimethylbut-1-yn-1-yl)biphenyl-2-yl]-5-fluoro-1,3-dimethyl-1H-pyrazole-4-carboxamide, 3-(difluoromethyl)-N-(4′-ethynylbiphenyl-2-yl)-1-methyl-1H-pyrazole-4-carboxamide, N-(4′-ethynylbiphenyl-2-yl)-5-fluoro-1,3-dimethyl-1H-pyrazole-4-carboxamide, 2-chloro-N-(4′-ethynylbiphenyl-2-yl)pyridine-3-carboxamide, 2-chloro-N-[4′-(3,3-dimethylbut-1-yn-1-yl)biphenyl-2-yl]pyridine-3-carboxamide, 4-(difluoromethyl)-2-methyl-N-[4′-(trifluoromethyl)biphenyl-2-yl]-1,3-thiazole-5-carboxamide, 5-fluoro-N-[4′-(3-hydroxy-3-methylbut-1-yn-1-yl)biphenyl-2-yl]-1,3-dimethyl-1H-pyrazole-4-carboxamide, 2-chloro-N-[4′-(3-hydroxy-3-methylbut-1-yn-1-yl)biphenyl-2-yl]pyridine-3-carboxamide, 3-(difluoromethyl)-N-[4′-(3-methoxy-3-methylbut-1-yn-1-yl)biphenyl-2-yl]-1-methyl-1H-pyrazole-4-carboxamide, 5-fluoro-N-[4′-(3-methoxy-3-methylbut-1-yn-1-yl)biphenyl-2-yl]-1,3-dimethyl-1H-pyrazole-4-carboxamide, 2-chloro-N-[4′-(3-methoxy-3-methylbut-1-yn-1-yl)biphenyl-2-yl]pyridine-3-carboxamide, (5-bromo-2-methoxy-4-methylpyridin-3-yl)(2,3,4-trimethoxy-6-methylphenyl)methanone, N-[2-(4-{[3-(4-chlorophenyl)prop-2-yn-1-yl]oxy}-3-methoxyphenyl)ethyl]-N2-(methylsulfonyl)valinamide, 4-oxo-4-[(2-phenylethyl)amino]butanoic acid and but-3-yn-1-yl {6-[({[(Z)-(1-methyl-1H-tetrazol-5-yl)(phenyl)methylene]amino}oxy)methyl]pyridin-2-yl}carbamate.

All pesticides (1) to (16) mentioned may, when they are capable on account of their functional groups, optionally form salts with suitable bases or acids.

Examples of bactericides include the following:
bronopol, dichlorophen, nitrapyrin, nickel dimethyldithiocarbamate, kasugamycin, octhilinone, furancarboxylic acid, oxytetracycline, probenazole, streptomycin, tecloftalam, copper sulfate and other copper preparations.

Examples of insecticides, acaricides and nematicides include the following:

(1) Acetylcholinesterase (AChE) inhibitors, such as, for example,
carbamates, for example alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or
organophosphates, for example acephate, azamethiphos, azinphos (methyl, ethyl), cadusafos, chlorethoxyfos, chlorfenvinphos, chlormephos, chlorpyrifos (methyl), coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion (methyl), phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(2) GABA-gated chloride channel antagonists, for example cyclodiene-organochlorines, e.g. chlordane and endosulfan; or phenylpyrazoles (fiproles), e.g. ethiprole and fipronil.

(3) Sodium channel modulators/voltage-gated sodium channel blockers, for example pyrethroids, e.g. acrinathrin, allethrin, d-cis-trans allethrin, d-trans allethrin, bifenthrin, bioallethrin, bioallethrin S-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans isomers], deltamethrin, empenthrin [(EZ)-(1R) isomers], esfenvalerate, etofenprox, fenpropathrin, fenvalerate, flucythrinate, flumethrin, tau-fluvalinate, halfenprox, imiprothrin, kadethrin, permethrin, phenothrin [(1R)-trans isomer], prallethrin, pyrethrins (pyrethrum), resmethrin, silafluofen, tefluthrin, tetramethrin, tetramethrin [(1R) isomers)], tralomethrin and transfluthrin; or DDT; or methoxychlor.

(4) Nicotinergic acetylcholine receptor (nAChR) agonists, for example neonicotinoids, e.g. acetamiprid, clothianidin, dinotefuran, imidacloprid, nitenpyram, thiacloprid and thiamethoxam; or nicotine.

(5) Allosteric activators of the nicotinergic acetylcholine receptor (nAChR), for example spinosyns, e.g. spinetoram and spinosad.

(6) Chloride channel activators, for example avermectins/milbemycins, e.g. abamectin, emamectin benzoate, lepimectin and milbemectin.

(7) Juvenile hormone imitators, for example juvenile hormone analogs, e.g. hydroprene, kinoprene and methoprene; or fenoxycarb; or pyriproxyfen.

(8) Active ingredients with unknown or nonspecific mechanisms of action, for example alkyl halides, e.g. methyl bromide and other alkyl halides; or chloropicrin; or sulfuryl fluoride; or borax; or tartar emetic.

(9) Selective antifeedants, for example pymetrozine; or flonicamid.

(10) Mite growth inhibitors, for example clofentezine, hexythiazox and diflovidazin; or etoxazole.

(11) Microbial disruptors of the insect gut membrane, for example Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins: Cry1Ab, Cry1Ac, Cry1 Fa, Cry2Ab, mCry3A, Cry3Ab, Cry3Bb, Cry34/35Ab1.

(12) Oxidative phosphorylation inhibitors, ATP disruptors, for example diafenthiuron; or organotin compounds, e.g. azocyclotin, cyhexatin and fenbutatin oxide; or propargite; or tetradifon.

(13) Oxidative phosphorylation decouplers that interrupt the H proton gradient, for example chlorfenapyr, DNOC and sulfluramid.

(14) Nicotinergic acetylcholine receptor antagonists, for example bensultap, cartap hydrochloride, thiocyclam, and thiosultap-sodium.

(15) Chitin biosynthesis inhibitors, type 0, for example bistrifluron, chlorfluazuron, diflubenzuron, flucycloxuron, flufenoxuron, hexaflumuron, lufenuron, novaluron, noviflumuron, teflubenzuron and triflumuron.

(16) Chitin biosynthesis inhibitors, type 1, for example buprofezin.

(17) Molting disruptors, dipteran, for example cyromazine.

(18) Ecdysone receptor agonists, for example chromafenozide, halofenozide, methoxyfenozide and tebufenozide.

(19) Octopaminergic agonists, for example amitraz.

(20) Complex-III electron transport inhibitors, for example hydramethylnon; or acequinocyl; or fluacrypyrim.

(21) Complex-I electron transport inhibitors, for example METI acaricides, e.g. fenazaquin, fenpyroximate, pyrimidifen, pyridaben, tebufenpyrad and tolfenpyrad; or rotenone (Derris).

(22) Voltage-dependent sodium channel blockers, for example indoxacarb; or metaflumizone.

(23) Inhibitors of acetyl-CoA carboxylase, for example tetronic and tetramic acid derivatives, e.g. spirodiclofen, spiromesifen and spirotetramat.

(24) Complex-IV electron transport inhibitors, for example phosphines, e.g. aluminum phosphide, calcium phosphide, phosphine and zinc phosphide; or cyanide.

(25) Complex-II electron transport inhibitors, for example cyenopyrafen.

(26) Ryanodine receptor effectors, for example diamides, e.g. chlorantraniliprole and flubendiamide.

Further active ingredients with an unknown mechanism of action, for example amidoflumet, azadirachtin, benclothiaz, benzoximate, bifenazate, bromopropylate, chinomethionat, cryolite, cyantraniliprole (Cyazypyr), cyflumetofen, dicofol, diflovidazin, fluensulfone, flufenerim, flufiprole, fluopyram, fufenozide, imidaclothiz, iprodione, pyridalyl, pyrifluquinazon and iodomethane; and additionally preparations based on Bacillus firmus (1-1582, BioNeem, Votivo) and the following known active compounds:
3-bromo-N-{2-bromo-4-chloro-6-[(1-cyclopropylethyl)carbamoyl]phenyl}-1-(3-chloropyridin-2-yl)-1H-pyrazole-5-carboxamide, 4-{[(6-bromopyrid-3-yl)methyl](2-fluoroethyl)amino}furan-2(5H)-one, 4-{[(6-fluoropyrid-3-yl)methyl](2,2-difluoroethyl)amino}furan-2(5H)-one, 4-{[(2-chloro-1,3-thiazol-5-yl)methyl](2-fluoroethyl)amino}furan-2(5H)-one, 4-{[(6-chloropyrid-3-yl)methyl](2-fluoroethyl)amino}furan-2(5H)-one, 4-{[(6-chloropyrid-3-yl)methyl](2,2-difluoroethyl)amino}furan-2(5H)-one, 4-{[(6-chloro-5-fluoropyrid-3-yl)methyl](methyl)amino}furan-2(5H)-one, 4-{[(5,6-dichloropyrid-3-yl)methyl](2-fluoroethyl)amino}furan-2(5H)-one, 4-{[(6-chloro-5-fluoropyrid-3-yl)methyl](cyclopropyl)amino}furan-2(5H)-one, 4-{[(6-chloropyrid-3-yl)methyl](cyclopropyl)amino}furan-2(5H)-one, 4-{[(6-chloropyrid-3-yl)methyl](methyl)amino}furan-2(5H)-one, {[1-(6-chloropyridin-3-yl)ethyl](methyl)oxido-λ4-sulfanylidene}cyanamide and its diastereomers {[(1R)-1-(6-chloropyridin-3-yl)ethyl](methyl)oxido-λ4-sulfanylidene}cyanamide (A) and {[(1S)-1-(6-chloropyridin-3-yl)ethyl](methyl)oxido-λ4-sulfanylidene}cyanamide (B) and also sulfoxaflor and its diastereomers [(R)-methyl(oxido){(1R)-1-[6-(trifluoromethyl)pyridin-3-yl]ethyl}-λ4-sulfanylidene]cyanamide (A1) and [(S)-methyl(oxido){(1S)-1-[6-(trifluoromethyl)pyridin-3-yl]ethyl}-λ4-sulfanylidene]cyanamide (A2), identified as diastereomer group A, [(R)-methyl(oxido){(1S)-1-[6-(trifluoromethyl)pyridin-3-yl]ethyl}-λ4-sulfanylidene]cyanamide (B1) and [(S)-methyl(oxido){(1R)-1-[6-(trifluoromethyl)pyridin-3-yl]ethyl}-λ4-sulfanylidene]cyanamide (B2), identified as diastereomer group B, and 11-(4-chloro-2,6-dimethylphenyl)-12-hydroxy-1,4-dioxa-9-azadispiro[4.2.4.2]tetradec-11-en-10-one, 3-(4′-fluoro-2,4-dimethylbiphenyl-3-yl)-4-hydroxy-8-oxa-1-azaspiro[4.5]dec-3-en-2-one, 1-{2-fluoro-4-methyl-5-[(2,2,2-trifluoroethyl)sulfinyl]phenyl}-3-(trifluoromethyl)-1H-1,2,4-triazol-5-amine, [(3S,4aR,12R,12aS,12bS)-3-[(cyclopropylcarbonyl)oxy]-6,12-dihydroxy-4,12b-dimethyl-11-oxo-9-(pyridin-3-yl)-1,3,4,4a,5,6,6a,12,12a,12b-decahydro-2H,11H-benzo[f]pyrano[4,3-b]chromen-4-yl]methyl cyclopropanecarboxylate, 2-cyano-3-(difluoromethoxy)-N,N-dimethylbenzenesulfonamide, 2-cyano-3-(difluoromethoxy)-N-methylbenzenesulfonamide, 2-cyano-3-(difluoromethoxy)-N-ethylbenzenesulfonamide, 4-(difluoromethoxy)-N-ethyl-N-methyl-1,2-benzothiazol-3-amine 1,1-dioxide, N-[1-(2,3-dimethylphenyl)-2-(3,5-dimethylphenyl)ethyl]-4,5-dihydro-1,3-thiazol-2-amine, {1′-[(2E)-3-(4-chlorophenyl)prop-2-en-1-yl]-5-fluorospiro[indole-3,4′-piperidin]-1(2H)-yl}(2-chloropyridin-4-yl)methanone, 3-(2,5-dimethylphenyl)-4-hydroxy-8-methoxy-1,8-diazaspiro[4.5]dec-3-en-2-one, 3-(2,5-dimethylphenyl)-8-methoxy-2-oxo-1,8-diazaspiro[4.5]dec-3-en-4-yl ethyl carbonate, 4-(but-2-yn-1-yloxy)-6-(3,5-dimethylpiperidin-1-yl)-5-fluoropyrimidine, (2,2,3,3,4,4,5,5-octafluoropentyl)(3,3,3-trifluoropropyl)malononitrile, (2,2,3,3,4,4,5,5-octafluoropentyl)(3,3,4,4,4-pentafluorobutyl)malononitrile, 8-[2-(cyclopropylmethoxy)-4-(trifluoromethyl)phenoxy]-3-[6-(trifluoromethyl)pyridazin-3-yl]-3-azabicyclo[3.2.1]octane, 2-ethyl-7-methoxy-3-methyl-6-[(2,2,3,3-tetrafluoro-2,3-dihydro-1,4-benzodioxin-6-yl)oxy]quinolin-4-yl methyl carbonate, 2-ethyl-7-methoxy-3-methyl-6-[(2,2,3,3-tetrafluoro-2,3-dihydro-1,4-benzodioxin-6-yl)oxy]quinolin-4-yl acetate, PF1364 (CAS Reg. No. 1204776-60-2), 5-[5-(3,5-dichlorophenyl)-5-(trifluoromethyl)-4,5-dihydro-1,2-oxazol-3-yl]-2-(1H-1,2,4-triazol-1-yl)benzonitrile, 5-[5-(2-chloropyridin-4-yl)-5-(trifluoromethyl)-4,5-dihydro-1,2-oxazol-3-yl]-2-(1H-1,2,4-triazol-1-yl)benzonitrile, 4-[5-(3,5-dichlorophenyl)-5-(trifluoromethyl)-4,5-dihydro-1,2-oxazol-3-yl]-2-methyl-N-{2-oxo-2-[(2,2,2-trifluoroethyl)amino]ethyl}benzamide, 4-{[(6-chloropyridin-3-yl)methyl](cyclopropyl)amino}-1,3-oxazol-2(5H)-one, 4-{[(6-chloropyridin-3-yl)methyl](2,2-difluoroethyl)amino}-1,3-oxazol-2(5H)-one, 4-{[(6-chloropyridin-3-yl)methyl](ethyl)amino}-1,3-oxazol-2(5H)-one, 4-{[(6-chloropyridin-3-yl)methyl](methyl)amino}-1,3-oxazol-2(5H)-one, NNI-0711, 1-acetyl-N-[4-(1,1,1,3,3,3-hexafluoro-2-methoxypropan-2-yl)-3-isobutylphenyl]-N-isobutyryl-3,5-dimethyl-1H-pyrazole-4-carboxamide, methyl 2-[2-({[3-bromo-1-(3-chloropyridin-2-yl)-1H-pyrazol-5-yl]carbonyl}amino)-5-chloro-3-methylbenzoyl]-2-methylhydrazinecarboxylate, methyl 2-[2-({[3-bromo-1-(3-chloropyridin-2-yl)-1H-pyrazol-5-yl]carbonyl}amino)-5-cyano-3-methylbenzoyl]-2-ethylhydrazinecarboxylate, methyl 2-[2-({[3-bromo-1-(3-chloropyridin-2-yl)-1H-pyrazol-5-yl]carbonyl}amino)-5-cyano-3-methylbenzoyl]-2-methylhydrazinecarboxylate, methyl 2-[3,5-dibromo-2-({[3-bromo-1-(3-chloropyridin-2-yl)-1H-pyrazol-5-yl]carbonyl}amino)benzoyl]-1,2-diethylhydrazinecarboxylate, methyl 2-[3,5-dibromo-2-({[3-bromo-1-(3-chloropyridin-2-yl)-1H-pyrazol-5-yl]carbonyl}amino)benzoyl]-2-ethylhydrazinecarboxylate, (5RS,7RS;5RS,7SR)-1-(6-chloro-3-pyridylmethyl)-1,2,3,5,6,7-hexahydro-7-methyl-8-nitro-5-propoxyimidazo[1,2-a]pyridine, 2-{6-[2-(5-fluoropyridin-3-yl)-1,3-thiazol-5-yl]pyridin-2-yl}pyrimidine, 2-{6-[2-(pyridin-3-yl)-1,3-thiazol-5-yl]pyridin-2-yl}pyrimidine, 1-(3-chloropyridin-2-yl)-N-[4-cyano-2-methyl-6-(methylcarbamoyl)phenyl]-3-{[5-(trifluoromethyl)-1H-tetrazol-1-yl]methyl}-1H-pyrazole-5-carboxamide, 1-(3-chloropyridin-2-yl)-N-[4-cyano-2-methyl-6-(methylcarbamoyl)phenyl]-3-{[5-(trifluoromethyl)-2H-tetrazol-2-yl]methyl}-1H-pyrazole-5-carboxamide, N-[2-(tert-butylcarbamoyl)-4-cyano-6-methylphenyl]-1-(3-chloropyridin-2-yl)-3-{[5-(trifluoromethyl)-1H-tetrazol-1-yl]methyl}-1H-pyrazole-5-carboxamide, N-[2-(tert-butylcarbamoyl)-4-cyano-6-methylphenyl]-1-(3-chloropyridin-2-yl)-3-{[5-(trifluoromethyl)-2H-tetrazol-2-yl]methyl}-1H-pyrazole-5-carboxamide, and (1E)-N-[(6-chloropyridin-3-yl)methyl]-N′-cyano-N-(2,2-difluoroethyl)ethanimidamide.

The active ingredients identified here by their common name are known and are described, for example, in the pesticide handbook (“The Pesticide Manual” 16^{th} Ed., British Crop Protection Council 2012) or can be searched for on the Internet (e.g. http://www.alanwood.net/pesticides).

In a preferred embodiment of the invention, namely especially when the one or more N-substituted pyrrolidones of the formula (I) are used to promote the penetration of one or more active agrochemical ingredients into plants, the one or more active agrochemical ingredients, in the use of the invention, are selected from systemic active agrochemical ingredients, i.e. active agrochemical ingredients that are absorbed by the plant through the leaves or via the roots and are passed onward in the sap stream, the transport system of the plant.

Among these, the one or more active agrochemical ingredients, particularly in the case of the use of the invention for promotion of penetration into plants, are preferably selected from active agrochemical ingredients having a log P s 4.5 (determined to EEC Directive 79/831 Annex V. A8 by HPLC, gradient method, acetonitrile/0.1% by weight aqueous phosphoric acid). More preferably, the one or more active agrochemical ingredients, in the use of the invention, are used for promotion of penetration into plants selected from active agrochemical ingredients having a log P≤4.5 and ≥−2.0, exceptionally preferably having a log P≤4.5 and ≥0.1, exceptionally preferably having a log P≤4.5 and ≥0.5 and most preferably having a log P≤3.0 and ≥0.5.

In a particularly preferred embodiment, the one or more active agrochemical ingredients, in the use of the invention, and especially in the use of the invention for promotion of penetration into plants, are selected from the group consisting of strobilurin fungicides, preferably azoxystrobin, pyraclostrobin, pycoxystrobin, fluoxastrobin, oryzastrobin, picoxystrobin, trifloxystrobin,
azole fungicides, preferably prothioconazole, tebuconazole, cyproconazole, difeconazole, metconazole, propiconazole, tetraconazole, tricyclazole and
further active ingredients, preferably fluxapyroxad, boscalid, bitertanol, prochloraz, thiophanate, chlorothalonil, dimethomorph, fenpropimorph, spiroxamine, trifluralin, metribuzin, saflufenacil, fenoxaprop-ethyl, acetolachlor, S-metolachlor, pendimethalin, pinoxaden, fluroxypyr, imidacloprid, thiacloprid, thiamethoxam, clothianidin, acetamiprid, emamectin benzoate, lambda-cyhalothrin, pymetrozine, chloantraniliprole, gibberellic acid, benzylaminopyrin, trinexapac-ethyl, etephon, thidiazuron.

Among the active agrochemical ingredients just mentioned, preferably in turn, the one or more active agrochemical ingredients, in the use of the invention, and especially in the use of the invention for promotion of penetration into plants, are selected from the group consisting of
strobilurin fungicides, preferably azoxystrobin, pyraclostrobin, fluoxastrobin, picoxystrobin, trifloxystrobin,
azole fungicides, preferably prothioconazole, tebuconazole, cyproconazole, propiconazole, and
further active ingredients, preferably fluxapyroxad, bitertanol, prochloraz, chlorothalonil, fenpropimorph, trifluralin, metribuzin, saflufenacil, fenoxaprop-ethyl, acetolachlor, S-metolachlor, pendimethalin, pinoxaden, fluroxypyr, imidacloprid, thiacloprid, thiamethoxam, clothianidin, acetamiprid, gibberellic acid, benzylaminopyrin.

Among these, preferably in turn, the one or more active agrochemical ingredients, in the use of the invention, and especially in the use of the invention for promotion of penetration into plants, are selected from the group consisting of azoxystrobin, pyraclostrobin, fluoxastrobin, trifloxystrobin, prothioconazole, tebuconazole, fluxapyroxad, bitertanol, prochloraz, chlorothalonil, fenpropimorph, trifluralin, metribuzin, saflufenacil, pendimethalin, fenoxaprop-ethyl, imidacloprid, thiacloprid, thiamethoxam, acetamiprid, gibberellic acid, benzylaminopyrin.

In a further particularly preferred embodiment, the one or more active agrochemical ingredients, in the use of the invention, and especially in the use of the invention for promotion of penetration into non-plant harmful organisms, are selected from the group consisting of
insecticides from the pyrethroid family, preferably cypermethrin, deltamethrin, permethrin, cyfluthrin, bifenthrin, lambda-cyhalothrin, gamma-cyhalothrin; organophosphate insecticides, preferably chlorpyrifos;
benzoylurea insecticides, preferably diflubenzuron, lufenuron;
other insecticides, preferably abamectin, emamectin benzoate, flubendiamide, fipronil, rynaxypyr, spiromesifen, spirodiclofen, fipronil, indoxacarb; and/or
amide fungicides, preferably prochloraz;
other fungicides, preferably trifloxystrobin, mancozeb, chlorothalonil; herbicides, preferably acetochlor, propanil, glufosinate.

Among the active agrochemical ingredients just mentioned, preferably in turn, the one or more active agrochemical ingredients, in the use of the invention, and especially in the use of the invention for promotion of penetration into non-plant harmful organisms, are selected from the group consisting of
insecticides from the pyrethroid family, preferably cypermethrin, deltamethrin, cyfluthrin, bifenthrin, lambda-cyhalothrin, gamma-cyhalothrin;
organophosphate insecticides, preferably chlorpyrifos;
benzoylurea insecticides, preferably diflubenzuron, lufenuron;
other insecticides, preferably abamectin, emamectin benzoate, flubendiamide, fipronil, rynaxypyr, spiromesifen, spirodiclofen, fipronil;
amide fungicides, preferably prochloraz;
other fungicides, preferably trifloxystrobin, mancozeb, chlorothalonil; herbicides, preferably acetochlor, propanil, glufosinate.

Further particularly preferred active agrochemical ingredients, in the use of the invention, include fenpicoxamid, bixafen, isopyrazam, fluopyram, penthiopyrad and abamectin.

The crop protection compositions used in the case of use of the invention may contain one or more additives.

Preferred additives are surfactants, nonpolar or polar solvents, cosolvents, stickers, wetters, dispersants, emulsifiers, further penetrants, preservatives, drift retardants, fillers, carriers, dyes, evaporation inhibitors, pH-influencing agents (buffers, acids and bases), viscosity-influencing agents (e.g. thickeners), functional polymers, adjuvants and/or defoamers.

In a preferred embodiment, the crop protection compositions used in the case of use of the invention contain one or more of the aforementioned additives.

A preferred group of additives is that of surfactants. These are anion-active, nonionogenic, cation-active and/or zwitterionic surfactants. Examples of such surfactants are listed below (where, in each case, EO=ethylene oxide units, PO=propylene oxide units and BO=butylene oxide units from the preparation point of view, or corresponding alkyleneoxy units in the surfactant molecules):

It is possible to use anion-active surfactants, for example:
1) anionic derivatives of fatty alcohols having 10-24 carbon atoms with 0-60 EO and/or 0-20 PO and/or 0-15 BO in any sequence in the form of ether carboxylates, sulfonates, sulfates and phosphates and the inorganic (e.g. alkali metal and alkaline earth metal) and organic salts (for example based on amine or alkanolamine) thereof, such as Genapol® LRO, Sandopan® products, Hostaphat/Hordaphos® products from Clariant;
2) anionic derivatives of copolymers consisting of EO, PO and/or BO units with a molecular weight of 400 to 10⁸ in the form of ether carboxylates, sulfonates, sulfates and phosphates and the inorganic (e.g. alkali metal and alkaline earth metal) and organic salts (for example based on amine or alkanolamine) thereof;
3) anionic derivatives of alkylene oxide adducts of C₁-C₉ alcohols in the form of ether carboxylates, sulfonates, sulfates and phosphates and the inorganic (e.g. alkali metal and alkaline earth metal) and organic salts (for example based on amine or alkanolamine) thereof, anionic derivatives of fatty acid alkoxylates in the form of ether carboxylates, sulfonates, sulfates and phosphates and the inorganic (e.g. alkali metal and alkaline earth metal) and organic salts (for example based on amine or alkanolamine) thereof;
4) salts of alkylated aromatic sulfonic acids, for example Phenylsulfonat® or Calsogen® products.

It is possible to use cation-active or zwitterionic surfactants, for example:
1) alkylene oxide adducts of fatty amines, quaternary ammonium compounds having 8 to 22 carbon atoms (C₈-C₂₂), for example the Genamin® C, L, O, T products;
2) surface-active zwitterionic compounds such as taurides, betaines and sulfobetaines in the form of Tegotain® products, Hostapon® T products and Arkopon® T products.

It is also possible to use nonionogenic surfactants, for example:
1) endgroup-capped and non-endgroup-capped fatty alcohols having 8-24 carbon atoms with 0-60 EO and/or 0-20 PO and/or 0-15 BO in any sequence. Examples of such compounds are Genapol® C, L, O, T, UD, UDD, X, XM products, Plurafac® and Lutensol® A, AT, ON, TO products, Marlipal®24 and 013 products, Dehypon® products, Ethylan® products, such as Ethylan CD 120;
2) fatty acid alkoxylates and triglyceride alkoxylates such as the Serdox®NOG products or the Emulsogen® products;
3) fatty acid amide alkoxylates such as the Comperlan® products;
4) alkylene oxide adducts of alkynediols such as the Surfynol® products; sugar derivatives such as amino and amido sugars;
5) glucitols;
6) silicone- or silane-based surface-active compounds such as the Tegopren® products and the SE® products, and the Bevaloid®, Rhodorsil® and Silcolapse® products;
7) interface-active sulfonamides;
8) interface-active polyacryloyl and polymethacryloyl derivatives such as the Sokalan® products;
9) surface-active polyamides such as modified gelatin or derivatized polyaspartic acid and derivatives thereof;
10) surfactant polyvinyl compounds such as modified PVP, such as the Luviskol® products and the Agrimer® products, or the derivatized polyvinyl acetates such as the Mowilith® products or the polyvinyl butyrates such as the Lutonal® products, the Vinnapas® and the Pioloform® products or modified polyvinyl alcohols such as the Mowiol® products;
11) surface-active polymers based on maleic anhydride and/or reaction products of maleic anhydride and maleic anhydride and/or reaction products of maleic anhydride-containing copolymers such as the Agrimer®-VEMA products;
12) surface-active derivatives of montan waxes, polyethylene waxes and polypropylene waxes, such as the Hoechst® waxes or the Licowet® and Licowax® products;
13) polyol-based alkylene oxide adducts such as Polyglykol® products;
14) interface-active polyglycerides and derivatives thereof;
15) alkyl polysaccharides and mixtures thereof, for example from the Atplus® series, preferably Atplus® 435;
16) alkyl polyglucosides in the form of the Agnique®-PG products, for example Agnique®-PG 8107 (fatty alcohol C₈-C₁₀-glucoside);
17) sorbitan esters in the form of the Span® or Tween® products;
18) cyclodextrin esters or ethers;
19) surface-active cellulose and algin, pectin and guar derivatives such as the Tylose® products, the Manutex® products and guar derivatives;
20) alkyl polyglycoside/alkyl polysaccharide mixtures based on C₈-C₁₀ fatty alcohol, such as Glucopon® 225 DK and Glucopon® 215 CSUP;
21) alkoxylated polyarylphenol compounds such as tristyryl-substituted phenols, for example in the form of the Emulsogen® TS products;
22) alkylated copolymers of ethylene oxide and propylene oxide, for example Emulsogen® 3510;
23) di- and triblock copolymers of alkylene oxides formed on the basis of ethylene oxide and propylene oxide and having average molar masses between 200 and 10 000, preferably 1000 to 4000 g/mol, where the proportion by mass of the polyethoxylated block varies between 10% and 80%, for example from the Synperonic® PE series (Uniqema), Pluronic® PE series (BASF), VOP® 32 or Genapol® PF series (Clariant), particular preference being given, for example, to products such as Genapol® 10500.

Preferred nonionogenic surfactants are also alkylglucamides and preferably N-methylglucamides made from fatty acids having 12 to 22 carbon atoms.

Nonpolar solvents used may be nonpolar organic solvents and/or nonpolar inorganic solvents or mixtures thereof.

Examples of nonpolar solvents in the context of the invention are
aliphatic or aromatic hydrocarbons, for example mineral oils or toluene, xylenes and naphthalene derivatives,
halogenated aliphatic or aromatic hydrocarbons, such as methylene chloride or chlorobenzene,
oils, for example vegetable-based oils such as corn kernel oil and rapeseed oil, or oil derivatives such as rapeseed oil methyl ester.

The cosolvents may be a single solvent or a mixture of two or more solvents. Suitable solvents for this purpose are all polar solvents that are compatible with the aqueous pesticide composition and form a homogeneous phase. Suitable cosolvents are, for example, monohydric alcohols such as methanol, ethanol, propanols, butanols, tetrahydrofurfuryl alcohol, benzyl alcohol or further polyhydric alcohols such as ethylene glycol, diethylene glycol or glycerol, or polyglycols such as polyethylene glycols, polypropylene glycols or mixed polyalkylene glycols (PAGs). Further suitable solvents are ethers, for example diethylene glycol diethyl ether (ethyl diglyme), tetraethylene glycol dimethyl ether (tetraglyme), propylene glycol monomethyl ether, propylene glycol dimethyl ether, dipropylene glycol monomethyl ether or dipropylene glycol dimethyl ether, amides, for example dimethylformamide, dimethylacetamide, N-methylpyrrolidone or N-ethylpyrrolidone, dimethyllactamide, dimethylcaprylamide, dimethylpelargonamide or dimethyldecanamide, dimethyllactamide, carbonates, for example ethylene carbonate, propylene carbonate, butylene carbonate or glycerol carbonate, or other cosolvents such as methyl caprylate caprate, methyl 5-(dimethylamino)-2-methyl-5-oxopentanoate (e.g. Rhodiasolv Polarclean), 1,3-dioxolane, γ-butyrolactone, cyclohexanone.

In a preferred embodiment, the crop protection composition used in the case of use of the invention does not contain any cosolvent.

The crop protection compositions used in the case of use of the invention may optionally contain preservatives as additives. The preservatives may be a single preservative or a mixture of two or more preservatives. Preservatives used may be organic acids and esters thereof, for example ascorbic acid, ascorbyl palmitate, sorbate, benzoic acid, methyl 4-hydroxybenzoate, propyl 4-hydroxybenzoate, propionates, phenol, 2-phenylphenate, 1,2-benzisothiazolin-3-one, formaldehyde, sulfurous acid and salts thereof. Examples include Mergal® K9N (Riedel) or Cobate® C.

The crop protection compositions used in the case of use of the invention may optionally contain drift retardants as additives. The drift retardants may be a single drift retardant or a mixture of two or more drift retardants. Drift retardants used may be water-soluble polymers, for example polyglycerol esters, polyacrylamides, acrylamide/acrylic acid polymers, sodium polyacrylate, carboxymethyl cellulose, hydroxyethyl cellulose, methyl cellulose, polysaccharides, natural and synthetic guar gum. In addition, it is also possible to use particular emulsions or self-emulsifying systems as drift retardants. Examples here include Synergen® OS from Clariant or InterLock® (Winfield).

The functional polymers which may be present as additive in the crop protection composition used in the case of use of the invention are high molecular weight compounds of synthetic or natural origin having a molar mass of greater than 10 000. The functional polymers may act, for example, as anti-drift agents or increase rain resistance.

In a further preferred embodiment of the invention, the crop protection compositions used in the case of use of the invention contain, as additive, one or more adjuvants as may be used in a commonly known manner in aqueous active ingredient compositions.

These are preferably fatty amine ethoxylates, etheramine ethoxylates, alkyl betaines or amidoalkyl betaines, amine oxides or amidoalkylamine oxides, alkyl polyglycosides or copolymers of glycerol, coconut fatty acid and phthalic acid.

These adjuvants are known from the literature as adjuvants in aqueous pesticide compositions and are described, for example, in WO 2009/029561.

The crop protection compositions used in the case of use of the invention may optionally contain defoamers as additives. The defoamers may be a single defoamer or a mixture of two or more defoamers. Suitable defoamers are fatty acid alkyl ester alkoxylates, organopolysiloxanes such as polydimethylsiloxanes and mixtures thereof with microfine, optionally silanized silica, perfluoroalkylphosphonates, perfluoroalkylphosphinates, paraffins, waxes and microcrystalline waxes, and mixtures thereof with silanized silica. Also advantageous are mixtures of various foam inhibitors, for example those of silicone oil, paraffin oil and/or waxes.

As already mentioned, the one or more N-substituted pyrrolidones of the formula (I), in the use of the invention, may be used in a crop protection composition.

This can take place, for example, in the form of liquid or solid concentrated crop protection compositions (for example “ready-to-use”, “in-can” or “built-in” formulations), where the concentrate formulations are typically diluted prior to use, especially with water, and are subsequently deployed to the fields by spray application as spray liquors.

Water-soluble concentrates (soluble liquids, abbreviated to SL) are an important form of crop protection compositions. They play a major role particularly for herbicides, these often being used in the form of water-soluble salts which are converted to their alkali metal salts or ammonium salts by neutralization of the acid form of the herbicides with suitable bases. Under some circumstances, a second, water-insoluble active agrochemical ingredient is also present in the crop protection composition. In that case, the preparation is a suspension concentrate (SC), even when an active agrochemical ingredient is dissolved in the aqueous phase.

Useful formulation types include all formulations that are deployed to plants or the propagation material thereof. The processes used for production thereof are generally familiar to the person skilled in the art and are described, for example, in Winnacker-Kichler, “Chemische Technologie” [Chemical Technology] volume 7, C. Hanser Verlag Munich, 4th ed., 1986; J. W. van Valkenburg, “Pesticide Formulations”, Marcel Dekker N. Y., 1973, K. Martens, “Spray Drying Handbook”, 3^{rd} Ed. 1979, G. Goodwin Ltd., London, or Mollet, Grubenmann, “Formulierungstechnik” [Formulation Technology], Wiley-VCH-Verlag, Weinheim, 2000.

Examples of formulation types are all of those mentioned in the “Manual on development and use of FAO and WHO specifications for pesticides” (FAO and WHO, 2002, appendix E) (using the GCPF formulation codes each with English abbreviation and designation): AB Grain bait; AE Aerosol dispenser; AL Any other liquid; AP Any other powder; CF Capsule Suspension for Seed Treatment; CG Encapsulated granule; CL Contact liquid or gel; CP Contact powder; CS Capsule suspension; DC Dispersible concentrate; DP Dustable powder; DS Powder for dry seed treatment; DT Tablet for direct application; EC Emulsifiable concentrate; ED Electrochargeable liquid; EG Emulsifiable Granule; EO Emulsion, water in oil; EP emulsifiable powder, ES Emulsion for seed treatment; EW Emulsion, oil in water; FG Fine granule; FS Flowable concentrate for seed treatment; GF Gel for Seed Treatment; GC Macrogranule; GL Emulsifiable gel; GP Flo-dust; GR Granule; GS Grease; GW Water soluble gel; HN Hot fogging concentrate; KK Combi-pack solid/liquid; KL Combi-pack liquid/liquid; KN Cold fogging concentrate; KP Combi-pack solid/solid; LA Lacquer; LS Solution for seed treatment; ME Microemulsion; MG Microgranule; OD oil dispersion; OF Oil miscible flowable concentrate/oil miscible suspension; OL Oil miscible liquid; OP Oil dispersible powder; PA Paste; PC Gel or paste concentrate; PO Pour-on; PR Plant rodlet; PS Seed coated with a pesticide; PT Pellet; RB Bait (ready for use); SA Spot-on; SC suspension concentrate, SD suspension concentrate for direct application, SE Suspo-emulsion; SG Water soluble granule; SL Soluble concentrate; SO Spreading oil; SP Water soluble powder; SS Water soluble powder for seed treatment; ST Water soluble tablet; SU Ultra-low volume (ULV) suspension; TB Tablet; TC Technical material; TK Technical concentrate; UL Ultra-low volume (ULV) liquid; VP Vapour releasing product; WG Water dispersible granules; WP Wettable powder; WS Water dispersible powder for slurry seed treatment; WT Water dispersible tablet; XX Others.

Preference is given to liquid formulation types. These include the following formulation types: DC (GCPF formulation code for dispersible concentrate); EC (GCPF formulation code for emulsion concentrate); EW (GCPF formulation code for oil-in-water emulsion); ES (GCPF formulation code for emulsion for seed treatment); FS (GCPF formulation code for flowable concentrate for seed treatment); EO (GCPF formulation code for water-in-oil emulsion); ME (GCPF formulation code for microemulsion); OD (GCPF formulation code for oil dispersion); SE (GCPF formulation code for suspoemulsion); SL (GCPF formulation code for water-soluble concentrate); CS (GCPF formulation code for capsule suspension) and AL (GCPF formulation code for ready-to-use liquid formulation, any other liquids for undiluted use).

Particular preference is given to emulsion concentrates (EC formulation type), water-soluble concentrates (SL formulation type), oil dispersions (OD formulation type), suspoemulsions (SE formulation type), microemulsions (ME formulation type) and oil-in-water emulsions (EW formulation type).

As likewise already mentioned, the inventive use of the one or more N-substituted pyrrolidones of the formula (I) may alternatively take place by what is called the tankmix method.

In the inventive use of the one or more N-substituted pyrrolidones of the formula (I) to promote the penetration of active agrochemical ingredients into plants or into non-plant harmful organisms, the one or more active agrochemical ingredients are simultaneously preferably used for monitoring and/or for control of unwanted plant growth, fungal diseases or insect infestation in plants, and more preferably for monitoring and/or for control of unwanted plant growth.

The plants treated in accordance with the invention may be crop plants, i.e. useful plants and ornamentals, or harmful plants. The harmful plants include, for example, all kinds of weeds. Among the crop plants, preference is given to economically important crops of useful plants, for example of fruit, such as apples or pears, of cereal, such as wheat, barley, rye, oats, millet/sorghum, rice, manioc and corn, or else crops of peanuts, sugarcane, cotton, soya, rape, potatoes, tomatoes, peas or other types of vegetable, and crops of ornamentals, such as cut flowers or ornamental trees. The crops of useful plants and ornamentals may, for example, also be transgenic crops, for example transgenic corn or transgenic soybeans.

The non-plant harmful organisms treated in accordance with the invention are insects, nematodes, phytoplasmas, bacteria such as Pseudomonadaceae, Rhizobiaceae, Enterobacteriaceae, Corynebacteriaceae and Streptomycetaceae, phytopathogens, fungi, viruses and viroids.

The temperature has a great effect on absorption into the plant, and an increase in temperature leads to an increase in mobility in the cuticle. Especially in the case of absorption into plants, mobility within the cuticle is a highly temperature-dependent process, but temperature also plays a role in the case of absorption into non-plant harmful organisms in diffusion through the skin of insects or the cell wall of fungi and generally in the usually “passive” diffusion through biomembranes. Solvents such as carboxamides or alkyl esters of fatty acids such as methyl oleate can act like an increase in temperature because they can penetrate very rapidly into and hence swell the cuticle. This means that they act particularly in the cuticle of the plant and often leave a majority of the active ingredient behind on the surface of the plant. The active ingredient is then frequently in crystalline form, encrusted with minerals from the water used or fixed in some other way, and is no longer available for transport to the target site in the plant or the non-plant harmful organism. Generally, penetration is at its highest immediately after application owing to the higher active ingredient concentrations or concentration gradient, and is often inadequate at low temperatures owing to temperature-dependent diffusion through the skin structures of plants or non-plant harmful organisms. Thus, penetration of active agrochemical ingredients into plants or into non-plant harmful organisms, particularly at cold temperatures, is significantly lower compared to higher temperatures. Since, in general, owing to loss processes, for instance degradation under light or volatility or rain resistance, but also for minimization of the input necessary, accelerated absorption is usually desirable for reasons of cost and environmental reasons, there is a search for means of promoting absorption particularly at low temperatures.

In the context of the present invention, it has additionally been found that, surprisingly, the one or more N-substituted pyrrolidones of the formula (I) are advantageously suitable, even at low temperatures, for promotion of penetration of one or more active agrochemical ingredients into plants or into non-plant harmful organisms and preferably into plants.

This is advantageous, for example, in the case of long-lasting cold weather conditions, but also, for example, when the temperatures, given the diurnal variations that prevail except in the tropics, in agriculture are at times within a cold range, i.e. when it is comparatively warm during the day but temperatures drop significantly at night.

The invention therefore also especially enables the use of one or more N-substituted pyrrolidones of the formula (I) for promotion of penetration of one or more active agrochemical ingredients into plants or into non-plant harmful organisms, preferably for promotion of penetration into plants, when penetration takes place at least at times at a temperature of not more than 25° C., particularly preferably at least at times at a temperature of not more than 20° C., especially preferably at least at times at a temperature of not more than 15° C. and exceptionally preferably at least at times at a temperature of not more than 10° C.

In a preferred embodiment of the invention, therefore, in the use of the invention, penetration of the one or more N-substituted pyrrolidones of the formula (I) for promotion of penetration of one or more active agrochemical ingredients into plants or into non-plant harmful organisms, and preferably for promotion of penetration of one or more active agrochemical ingredients into plants, takes place at least at times at a temperature of not more than 25° C., preferably at least at times at a temperature of not more than 20° C., more preferably at least at times at a temperature of not more than 15° C. and especially preferably at least at times at a temperature of not more than 10° C.

The invention also further provides a method of promoting the penetration of active agrochemical ingredients into plants or into non-plant harmful organisms, wherein one or more active agrochemical ingredients are applied to the plants simultaneously or sequentially together with one or more N-substituted pyrrolidones of the formula (I). In this method of the invention, in turn, preference is given to those N-substituted pyrrolidones of the formula (I), active agrochemical ingredients, use forms (e.g. crop protection compositions or tankmix applications and spray liquors), additives, plants and non-plant harmful organisms that are also preferred in the use of the invention of the one or more N-substituted pyrrolidones of the formula (I) for promotion of penetration of active agrochemical ingredients into plants or non-plant harmful organisms.

As in the case of use of the invention, penetration in the method of the invention for promotion of penetration of active agrochemical ingredients into plants or into non-plant harmful organisms, and preferably for promotion of penetration of active agrochemical ingredients into plants, in a preferred embodiment of the invention, also takes place at least at times at a temperature of not more than 25° C., preferably at least at times at a temperature of not more than 20° C., more preferably at least at times at a temperature of not more than 15° C. and especially preferably at least at times at a temperature of not more than 10° C.

The present invention also further provides the above-described crop protection compositions that can be used in the case of the inventive use of the one or more N-substituted pyrrolidones of the formula (I) for promoting the penetration of active agrochemical ingredients into plants or into non-plant harmful organisms.

Among these crop protection compositions of the invention, preference is given in turn to those that are also preferred in the case of the inventive use of the one or more N-substituted pyrrolidones of the formula (I) for promoting the penetration of active agrochemical ingredients into plants or into non-plant harmful organisms.

In a preferred embodiment of the invention, the crop protection compositions of the invention contain
a) 1% to 90% by weight and preferably 5% to 70% by weight of one or more N-substituted pyrrolidones of the formula (I) and
b) 1% to 90% by weight and preferably 2.5% to 70% by weight of one or more active agrochemical ingredients.

The crop protection compositions of the invention just mentioned may contain one or more additives. They contain preferably 0% to 98% by weight and more preferably 1% to 60% by weight of one or more additives.

In a further preferred embodiment of the invention, the crop protection compositions of the invention contain
a) 1% to 50% by weight, preferably 5% to 40% by weight and more preferably 5% to 30% by weight of one or more N-substituted pyrrolidones of the formula (I) and
b) 1% to 90% by weight, preferably 5% to 60% by weight and more preferably 2.5% to 50% by weight of one or more active agrochemical ingredients.

The crop protection compositions of the invention just mentioned may contain one or more additives. They contain preferably 0% to 98% by weight and more preferably 1% to 50% by weight of one or more additives.

In a further preferred embodiment of the invention, the crop protection compositions of the invention contain water.

In a further preferred embodiment of the invention, the crop protection compositions of the invention are in the form of an aqueous spray liquor and contain
a) 0.001% to 99% by weight, preferably 0.01% to 50% by weight and more preferably 0.02% to 1% by weight of one or more N-substituted pyrrolidones of the formula (I) and
b) 0.001% to 10% by weight, preferably 0.002% to 5% by weight and more preferably 0.0025% to 3% by weight of one or more active agrochemical ingredients.

It has been found that, surprisingly, the crop protection compositions of the invention are suitable for production of high-efficacy spray liquors with a very low active ingredient content. The invention therefore also relates to aqueous spray liquors comprising the above-described components a) and b), where the content of component b) is less than 0.05 g/L, preferably 0.01 to 0.03 g/L.

In a particularly preferred embodiment of this spray liquor with a low active ingredient content, the content of component a) is less than 0.1% by weight, more preferably 0.015% to 0.05% by weight, based on the total amount of the spray liquor.

The crop protection compositions of the invention in the form of an aqueous spray liquor that have just been mentioned may contain one or more additives. They contain preferably 0% to 99% by weight and more preferably 0.01% to 80% by weight of one or more additives.

In the crop protection compositions of the invention, preference is given, inter alia, to the N-substituted pyrrolidones of the formula (I), the active agrochemical ingredients and the additives optionally present that are also preferred in the use of the invention of the one or more N-substituted pyrrolidones of the formula (I) for promotion of penetration of active agrochemical ingredients into plants or into non-plant harmful organisms.

As in the case of use of the invention, the stated amounts relating to the N-substituted pyrrolidones of the formula (I), the active agrochemical ingredients and the additives are based on the total weight of the crop protection compositions of the invention and, in the case of active agrochemical ingredients that are acids in protonated form but are used in the form of their water-soluble salts, on the amount of free acid, called the acid equivalent (a.e.).

The active agrochemical ingredients described as preferred in the uses of the invention are also used with preference as component b) in the crop protection compositions of the invention.

Preferred components b) are selected from the group consisting of fungicides, bactericides, insecticides, acaricides, nematicides, herbicides, plant growth regulators, plant nutrients, repellents, molluscicides and rodenticides. Particularly preferred components b) are selected from the group consisting of herbicides, fungicides, insecticides, nematicides and/or plant growth regulators.

The invention more preferably relates to crop protection compositions comprising, as well as component a), one or more active agrochemical ingredients as component b) that are selected from the group consisting of
strobilurin fungicides, preferably azoxystrobin, pyraclostrobin, pycoxystrobin, fluoxastrobin, oryzastrobin, picoxystrobin, trifloxystrobin, and/or
azole fungicides, preferably prothioconazole, tebuconazole, cyproconazole, difeconazole, metconazole, propiconazole, tetraconazole, tricyclazole and/or
further active ingredients, preferably fenpicoxamid, fluxapyroxad, boscalid, bitertanol, prochloraz, thiophanate, chlorothalonil, bixafen, isopyrazam, fluopyram, penthiopyrad, dimethomorph, fenpropimorph, spiroxamine, trifluralin, metribuzin, saflufenacil, fenoxaprop-ethyl, acetolachlor, S-metolachlor, pendimethalin, pinoxaden, fluroxypyr, abamectin, imidacloprid, thiacloprid, thiamethoxam, clothianidin, acetamiprid, emamectin benzoate, lambda-cyhalothrin, pymetrozine, chloantraniliprole, gibberellic acid, benzylaminopyrin, trinexapac-ethyl, etephon, thidiazuron.

Active agrochemical ingredients used with particular preference as component b) are selected from the group consisting of
strobilurin fungicides, preferably azoxystrobin, pyraclostrobin, fluoxastrobin, picoxystrobin, trifloxystrobin, and/or
azole fungicides, preferably prothioconazole, tebuconazole, cyproconazole, propiconazole, metconazole and/or
further active ingredients, preferably fenpicoxamid, fluxapyroxad, bitertanol, prochloraz, chlorothalonil, bixafen, isopyrazam, fluopyram, penthiopyrad, fenpropimorph, trifluralin, metribuzin, saflufenacil, fenoxaprop-ethyl, acetolachlor, S-metolachlor, pendimethalin, pinoxaden, fluroxypyr, abamectin, imidacloprid, thiacloprid, thiamethoxam, clothianidin, acetamiprid, gibberellic acid, trinexapac-ethyl, benzylaminopyrin.

Active agrochemical ingredients used with especial preference as component b) are selected from the group consisting of azoxystrobin, pyraclostrobin, fluoxastrobin, trifloxystrobin, prothioconazole, tebuconazole, fluxapyroxad, bitertanol, metconazole, prochloraz, chlorothalonil, fenpropimorph, trifluralin, metribuzin, saflufenacil, pendimethalin, fenoxaprop-ethyl, imidacloprid, thiacloprid, thiamethoxam, acetamiprid, benzylaminopyrin; and/or are selected from the group consisting of
insecticides from the pyrethroid family, preferably cypermethrin, deltamethrin, permethrin, cyfluthrin, bifenthrin, lambda-cyhalothrin, gamma-cyhalothrin; and/or
organophosphate insecticides, preferably chlorpyrifos; and/or
benzoylurea insecticides, preferably diflubenzuron, lufenuron; and/or
other insecticides, preferably abamectin, emamectin benzoate, flubendiamide, fipronil, rynaxypyr, spiromesifen, spirodiclofen, fipronil, indoxacarb; and/or
amide fungicides, preferably prochloraz; and/or
other fungicides, preferably trifloxystrobin, mancozeb, chlorothalonil; bixafen, isopyrazam, fluopyram, penthiopyrad; and/or
herbicides, preferably acetochlor, propanil, glufosinate; and/or
plant growth regulators, especially trinexapac-ethyl or gibberellic acid.

The invention is elucidated in detail by examples hereinafter, without restricting it thereto.

Percentages relating to amounts of material or substance should be regarded as percent by weight (% by weight), unless explicitly stated otherwise.

### EXAMPLES

Penetration Test (Penetration into Plants)

In this test, the penetration of active ingredients through enzymatically isolated cuticles of apple or pear tree leaves was measured.

Leaves that had been cut in the fully developed state off apple trees of the Golden Delicious variety or pear trees were used. The cuticles were isolated by
first filling leaf disks labeled on the underside with dye and formed by punching by means of vacuum infiltration with a pectinase solution (0.2% to 2% strength) buffered to a pH of between 3 and 4,
then adding sodium azide and
leaving the leaf disks thus treated to stand until dissolution of the original leaf structure and until detachment of the noncellular cuticles.

All that were used thereafter were the cuticles of the top sides of the leaves that were free of stomata and hairs. They were repeatedly washed alternately with water and a buffer solution of pH 7. The clean cuticles obtained were finally applied to Teflon platelets, and smoothed and dried with a gentle air stream.

In the next step, the cuticle membranes thus obtained were placed into stainless steel diffusion cells (=transport chambers) for membrane transport studies. For this purpose, the cuticles were placed with tweezers at the midpoint onto the edges of the diffusion cells that had been coated with silicone grease and closed with a likewise greased ring. The arrangement had been chosen such that the morphological outer face of the cuticles faced the outside, i.e. the air, while the original inner face faced the interior of the diffusion cell. The diffusion cells were filled with water or with a mixture of water and solvent.

To determine penetration, 9 μL in each case of a spray liquor of the composition specified in the examples was applied to the outer face of a cuticle.

CIPAC water was used in each of the spray liquors.

After the spray liquors had been applied, the water was allowed to evaporate in each case, then the chambers were each turned around and they were placed into thermostated baths, while air at a defined temperature and air humidity was blown onto the outer face of the cuticle. The penetration that set in took place at a relative air humidity of 60% and a set temperature as specified. The active ingredient penetration was measured by means of high-performance liquid chromatography (HPLC).

As apparent from the examples adduced in tables 1 to 20, the presence of N-(n-butyl)-2-pyrrolidone leads to a considerable increase in uptake compared to the formulations where N-(n-butyl)-2-pyrrolidone is absent. The alternatives to N-(n-butyl)-2-pyrrolidone used are examples of commercial feedstocks for formulations.

The values for “% penetration” reported in the tables which follow report what percentage of the amount of substance applied to the plant penetrates into the plant. The values reported are averages.

The abbreviations used in the tables have the following meaning:
20 SG: short form of “Mospilan® 20 SG”
Calypso® SC 480: commercial formulation of thiacloprid
Custodia® SC 320: commercial formulation of azoxystrobin and tebuconazole
DAT: days after treatment
DF75: short form of “Dimetric© DF75”
Dimetric® DF75: commercial formulation of metribuzin
DMSO: dimethyl sulfoxide
EC 540: commercial formulation of trifluralin
Galaster® BL97: butyl lactate
Genagen® NBP: NBP (neat)
Mospilan® 20 SG: commercial formulation of acetamiprid
n: number of treatments and accompanying measurements
NBP: N-(n-butyl)-2-pyrrolidone
NMP: N-methylpyrrolidone
Orkestra® SC 500: commercial formulation of fluxapyroxad and pyraclostrobin
RT: room temperature (23 to 25° C.)
SC320: short form of “Custodia® SC 320”
SC480: short form of “Calypso® SC 480”
SC500: short form of “Orkestra® SC 500”
EC 18: commercial formulation of abamectin (emulsion concentrate)
SC 200: commercial formulation of rynaxypyr (suspension concentrate)
Acceptor medium: solution of forchlorfenuron in a water/diethylene glycol medium
Prothioconazole x % RW: prothioconazole powder with active ingredient content x % by weight
Genagen® PA: dimethylpelargonamide
Genagen® 4296: dimethyldecanamide
Agsolex® 08: N-octylpyrrolidone
Solvesso® 200 ND: mixture of aromatic hydrocarbons
Emulsogen® 3510: alkylated copolymers of ethylene oxide and propylene oxide
Synergen® 848: alkylated copolymers of ethylene oxide and propylene oxide
Synergen® W03: alkylsulfosuccinate, Na salt in hydrocarbons
Synergen® W09: alkylsulfosuccinate, Na salt in white oil
Genapol® X 090: isotridecyl alcohol with 9 ethylene oxide units
Emulsogen® MTP 070: alkylated copolymers of ethylene oxide and propylene oxide
Emulsogen® EL 300: castor oil with 30 ethylene oxide units
Emulsogen® EL 360: castor oil with 36 ethylene oxide units
Momentive® SAG 1571: polydimethylsiloxane emulsion
Trinexapac Ethyl x % RW: trinexapac-ethyl powder with active ingredient content x % by weight
Hostaphat® 1306: isotridecyl phosphate with 6 ethylene oxide units
Emulsogen® ELO 200: modified castor oil ethoxylates
Synergen® SOC: tankmix adjuvant
MSO: sunflower oil methyl ester

### Example 1: Penetration Tests with Metribuzin at 10° C. In Pear

TABLE 1
Penetration results after 6 hours and after 2 days of example 1

| | | | Metribuzin | % metribuzin | % metribuzin |
|---|---|---|---|---|---|
| | Formulation/test substance | | concentration (g/L) | penetration at | penetration at |
| | in the aqueous spray liquor | Active | in the aqueous | 10° C. in pear | 10° C. in pear |
| Example | (% by wt.) | ingredient | spray liquor | after 6 h//n = 5-7 | after 2 DAT//n = 5-7 |
| 1-1 | Dimetric ® DF75 | metribuzin | 2.25 | 0.57 | 1.28 |
| 1-2 | DF75/NMP (0.1) | metribuzin | 2.25 | 0.48 | 1.25 |
| 1-3 | DF75/NMP (0.5) | metribuzin | 2.25 | 0.83 | 3.51 |
| 1-4 | DF75/DMSO (0.1) | metribuzin | 2.25 | 0.28 | 1 |
| 1-5 | DF75/DMSO (0.5) | metribuzin | 2.25 | 0.64 | 2.02 |
| 1-6 | DF75/NBP (0.1) | metribuzin | 2.25 | 1.88 | 3.54 |
| 1-7 | DF75/NBP (0.3) | metribuzin | 2.25 | 8.93 | 11.64 |
| 1-8 | DF75/NBP (0.5) | metribuzin | 2.25 | 16.88 | 21.05 |

### Procedure for Examples 1-1 to 1-8

The formulation (Dimetric® DF75 or DF75) was diluted with water, such that the dilution contained a metribuzin concentration of 4.50 g/L. By mixing this diluted formulation with the appropriate amount of test substance (NMP, DMSO or NBP) in water, the desired concentration of test substance (0.1% by weight, 0.3% by weight or 0.5% by weight) and the active agrochemical ingredient metribuzin (2.25 g/L) in the aqueous spray liquor was established. Penetration through isolated pear cuticles was measured at a temperature of 10° C. after 6 h and after 2 days after application (2 DAT).

The tests of examples 2 to 17 and 20 to 22 were conducted analogously to example 1, but taking account of the data and conditions specified in tables 2 to 20.

### Example 2: Penetration Tests with Metribuzin at Room Temperature in Pear

TABLE 2
Penetration results after 6 hours and after 2 days of example 2

| | | | Metribuzin | % metribuzin | % metribuzin |
|---|---|---|---|---|---|
| | Formulation/test substance | | concentration (g/L) | penetration at | penetration at |
| | in the aqueous spray liquor | Active | in the aqueous | RT in pear | RT in pear |
| Example | (% by wt.) | ingredient | spray liquor | after 6 h//n = 5-7 | after 2 DAT//n = 5-7 |
| 2-1 | Dimetric ® DF75 | metribuzin | 2.25 | 2.93 | 26.81 |
| 2-2 | DF75/NMP (0.1) | metribuzin | 2.25 | 1.82 | 7.61 |
| 2-3 | DF75/NMP (0.5) | metribuzin | 2.25 | 5 | 15.84 |
| 2-4 | DF75/DMSO (0.1) | metribuzin | 2.25 | 1.82 | 6.9 |
| 2-5 | DF75/DMSO (0.5) | metribuzin | 2.25 | 0.94 | 5.47 |
| 2-6 | DF75/NBP (0.1) | metribuzin | 2.25 | 3.43 | 13.46 |
| 2-7 | DF75/NBP (0.3) | metribuzin | 2.25 | 8.78 | 18.14 |
| 2-8 | DF75/NBP (0.5) | metribuzin | 2.25 | 18.6 | 32.41 |

### Example 3: Penetration Tests with Metribuzin at 10° C. in Pear

TABLE 3
Penetration results after 6 hours and after 2 days of example 3

| | | | Metribuzin | % metribuzin | % metribuzin |
|---|---|---|---|---|---|
| | Formulation/test substance | | concentration (g/L) | penetration at | penetration at |
| | in the aqueous spray liquor | Active | in the aqueous | 10° C. in pear | 10° C. in pear |
| Example | (% by wt.) | ingredient | spray liquor | after 6 h//n = 5-7 | after 2 DAT//n = 5-7 |
| 3-1 | Dimetric ® DF75 | metribuzin | 2.25 | 0.1 | 1.14 |
| 3-2 | DF75/isophorone (0.1) | metribuzin | 2.25 | 0.27 | 1.87 |
| 3-3 | DF75/isophorone (0.3) | metribuzin | 2.25 | 0.24 | 1.54 |
| 3-4 | DF75/isophorone (0.5) | metribuzin | 2.25 | 0.45 | 4.13 |
| 3-5 | DF75/NBP (0.1) | metribuzin | 2.25 | 0.86 | 1.86 |
| 3-6 | DF75/NBP (0.3) | metribuzin | 2.25 | 6.63 | 11.45 |
| 3-7 | DF75/NBP (0.5) | metribuzin | 2.25 | 14.7 | 20.79 |

### Example 4: Penetration Tests with Azoxystrobin at 1000 in Apple

TABLE 4
Penetration results after 6 hours and after 3 days of example 4

| | | | Azoxystrobin | % azoxystrobin | % azoxystrobin |
|---|---|---|---|---|---|
| | Formulation/test substance | | concentration (g/L) | penetration at | penetration at |
| | in the aqueous spray liquor | Active | in the aqueous | 10° C. in apple | 10° C. in apple |
| Example | (% by wt.) | ingredients | spray liquor | after 6 h//n = 5-7 | after 3 DAT//n = 5-7 |
| 4-1 | Custodia ® SC 320 | azoxystrobin and | 0.45 | 0.21 | 0.88 |
| | | tebuconazole | | | |
| 4-2 | SC320/NMP (0.1) | azoxystrobin and | 0.45 | 0 | 0.72 |
| | | tebuconazole | | (=undetectable) | |
| 4-3 | SC320/NMP (0.5) | azoxystrobin and | 0.45 | 0 | 0.61 |
| | | tebuconazole | | | |
| 4-4 | SC320/NBP (0.1) | azoxystrobin and | 0.45 | 0 | 0.46 |
| | | tebuconazole | | | |
| 4-5 | SC320/NBP (0.5) | azoxystrobin and | 0.45 | 0.32 | 3.04 |
| | | tebuconazole | | | |

For penetration tests on tebuconazole at 1000 in apple see example 6

### Example 5: Penetration Tests with Azoxystrobin at Room Temperature in Apple

TABLE 5
Penetration results after 6 hours and after 3 days of example 5

| | | | Azoxystrobin | % azoxystrobin | % azoxystrobin |
|---|---|---|---|---|---|
| | Formulation/test substance | | concentration (g/L) | penetration at | penetration at |
| | in the aqueous spray liquor | Active | in the aqueous | RT in apple | RT in apple |
| Example | (% by wt.) | ingredients | spray liquor | after 6 h//n = 5-7 | after 3 DAT//n = 5-7 |
| 5-1 | Custodia ® SC 320 | azoxystrobin and | 0.45 | 0.54 | 3.61 |
| | | tebuconazole | | | |
| 5-2 | SC320/NMP (0.1) | azoxystrobin and | 0.45 | 0.47 | 2.47 |
| | | tebuconazole | | | |
| 5-3 | SC320/NMP (0.5) | azoxystrobin and | 0.45 | 1.28 | 8.76 |
| | | tebuconazole | | | |
| 5-4 | SC320/NBP (0.1) | azoxystrobin and | 0.45 | 0.33 | 1.43 |
| | | tebuconazole | | | |
| 5-5 | SC320/NBP (0.5) | azoxystrobin and | 0.45 | 5.06 | 13.85 |
| | | tebuconazole | | | |

For penetration tests on tebuconazole at room temperature in apple see example 7

### Example 6: Penetration Tests with Tebuconazole at 1000 in Apple

TABLE 6
Penetration results after 6 hours and after 3 days of example 6

| | | | Tebuconazole | % tebuconazole | % tebuconazole |
|---|---|---|---|---|---|
| | Formulation/test substance | | concentration (g/L) | penetration at | penetration at |
| | in the aqueous spray liquor | Active | in the aqueous | 10° C. in apple | 10° C. in apple |
| Example | (% by wt.) | ingredients | spray liquor | after 6 h//n = 5-7 | after 3 DAT//n = 5-7 |
| 6-1 | Custodia ® SC 320 | azoxystrobin and | 0.75 | 0.37 | 0.91 |
| | | tebuconazole | | | |
| 6-2 | SC320/NMP (0.1) | azoxystrobin and | 0.75 | 0.12 | 1.55 |
| | | tebuconazole | | | |
| 6-3 | SC320/NMP (0.5) | azoxystrobin and | 0.75 | 0.12 | 3.85 |
| | | tebuconazole | | | |
| 6-4 | SC320/NBP (0.1) | azoxystrobin and | 0.75 | 0.06 | 2.14 |
| | | tebuconazole | | | |
| 6-5 | SC320/NBP (0.5) | azoxystrobin and | 0.75 | 7.01 | 18.17 |
| | | tebuconazole | | | |

For penetration tests on azoxystrobin at 1000 in apple see example 4

### Example 7: Penetration Tests with Tebuconazole at Room Temperature in Apple

TABLE 7
Penetration results after 6 hours and after 3 days of example 7

| | | | Tebuconazole | % tebuconazole | % tebuconazole |
|---|---|---|---|---|---|
| | Formulation/test substance | | concentration (g/L) | penetration at | penetration at |
| | in the aqueous spray liquor | Active | in the aqueous | RT in apple | RT in apple |
| Example | (% by wt.) | ingredients | spray liquor | after 6 h//n = 5-7 | after 3 DAT//n = 5-7 |
| 7-1 | Custodia ® SC 320 | azoxystrobin and | 0.75 | 2.54 | 22.72 |
| | | tebuconazole | | | |
| 7-2 | SC320/NMP (0.1) | azoxystrobin and | 0.75 | 3.67 | 20.73 |
| | | tebuconazole | | | |
| 7-3 | SC320/NMP (0.5) | azoxystrobin and | 0.75 | 9.2 | 71.3 |
| | | tebuconazole | | | |
| 7-4 | SC320/NBP (0.1) | azoxystrobin and | 0.75 | 4.27 | 12.41 |
| | | tebuconazole | | | |
| 7-5 | SC320/NBP (0.5) | azoxystrobin and | 0.75 | 30.4 | 79.6 |
| | | tebuconazole | | | |

For penetration tests on azoxystrobin at room temperature in apple see example 5

### Example 8: Penetration Tests with Fluxapyroxad at 1000 in Apple

TABLE 8
Penetration results after 1 day and after 3 days of example 8

| | Formulation/ | | Fluxapyroxad | % fluxapyroxad | % fluxapyroxad |
|---|---|---|---|---|---|
| | test substance | | concentration | penetration at | penetration at |
| | in the aqueous | | (g/L) in the | 10° C. in apple | 10° C. in apple |
| | spray liquor | Active | aqueous | after 1 DAT// | after 3 DAT// |
| Example | (% by wt.) | ingredients | spray liquor | n = 5-7 | n = 5-7 |
| 8-1 | Orkestra ® SC 500 | fluxapyroxad and | 0.285 | 0.12 | 0.25 |
| | | pyraclostrobin | | | |
| 8-2 | SC500/isophorone (0.3) | fluxapyroxad and | 0.285 | 0 | 0.23 |
| | | pyraclostrobin | | | |
| 8-3 | SC500/NBP (0.3) | fluxapyroxad and | 0.285 | 1.45 | 3.0 |
| | | pyraclostrobin | | | |

### Example 9: Penetration Tests with Fluxapyroxad at Room Temperature in Apple

TABLE 9
Penetration results after 1 day and after 3 days of example 9

| | Formulation/ | | Fluxapyroxad | % fluxapyroxad | % fluxapyroxad |
|---|---|---|---|---|---|
| | test substance | | concentration | penetration at | penetration at |
| | in the aqueous | | (g/L) in the | RT in apple | RT in apple |
| | spray liquor | Active | aqueous | after 1 DAT// | after 3 DAT// |
| Example | (% by wt.) | ingredients | spray liquor | n = 5-7 | n = 5-7 |
| 9-1 | Orkestra ® SC 500 | fluxapyroxad and | 0.285 | 1.99 | 3.84 |
| | | pyraclostrobin | | | |
| 9-2 | SC500/isophorone (0.3) | fluxapyroxad and | 0.285 | 1.01 | 3.16 |
| | | pyraclostrobin | | | |
| 9-3 | SC500/NBP (0.3) | fluxapyroxad and | 0.285 | 10.14 | 21.39 |
| | | pyraclostrobin | | | |

### Example 10: Penetration Tests with Pyraclostrobin at 1000 in Pear

TABLE 10
Penetration results after 1 day and after 3 days of example 10

| | Formulation/ | | Pyraclostrobin | % pyraclostrobin | % pyraclostrobin |
|---|---|---|---|---|---|
| | test substance | | concentration | penetration at | penetration at |
| | in the aqueous | | (g/L) in the | 10° C. in pear | 10° C. in pear |
| | spray liquor | Active | aqueous | after 1 DAT// | after 3 DAT// |
| Example | (% by wt.) | ingredients | spray liquor | n = 5-7 | n = 5-7 |
| 10-1 | Orkestra ® SC 500 | fluxapyroxad and | 0.566 | 0.04 | 0.12 |
| | | pyraclostrobin | | | |
| 10-2 | SC500/NMP (0.3) | fluxapyroxad and | 0.566 | 0.05 | 0.29 |
| | | pyraclostrobin | | | |
| 10-3 | SC500/DMSO (0.3) | fluxapyroxad and | 0.566 | 0.02 | 0.06 |
| | | pyraclostrobin | | | |
| 10-4 | SC500/NBP (0.3) | fluxapyroxad and | 0.566 | 3.77 | 5.45 |
| | | pyraclostrobin | | | |

### Example 11: Penetration Tests with Pyraclostrobin at Room Temperature in Pear

TABLE 11
Penetration results after 1 day and after 3 days of example 11

| | Formulation/ | | Pyraclostrobin | % pyraclostrobin | % pyraclostrobin |
|---|---|---|---|---|---|
| | test substance | | concentration | penetration at | penetration at |
| | in the aqueous | | (g/L) in the | RT in pear | RT in pear |
| | spray liquor | Active | aqueous | after 1 DAT// | after 3 DAT// |
| Example | (% by wt.) | ingredients | spray liquor | n = 5-7 | n = 5-7 |
| 11-1 | Orkestra ® SC 500 | fluxapyroxad and | 0.566 | 0.56 | 2.18 |
| | | pyraclostrobin | | | |
| 11-2 | SC500/NMP (0.3) | fluxapyroxad and | 0.566 | 2.51 | 9.65 |
| | | pyraclostrobin | | | |
| 11-3 | SC500/DMSO (0.3) | fluxapyroxad and | 0.566 | 0.72 | 2.62 |
| | | pyraclostrobin | | | |
| 11-4 | SC500/NBP (0.3) | fluxapyroxad and | 0.566 | 13.43 | 29.44 |
| | | pyraclostrobin | | | |

### Example 12: Penetration Tests with Thiacloprid at 1000 in Pear

TABLE 12
Penetration results after 6 hours and after 2 days of example 12

| | Formulation/ | | Thiacloprid | % thiacloprid | % thiacloprid |
|---|---|---|---|---|---|
| | test substance | | concentration | penetration at | penetration at |
| | in the aqueous | | (g/L) in the | 10° C. in pear | 10° C. in pear |
| | spray liquor | Active | aqueous | after 6 h// | after 2 DAT// |
| Example | (% by wt.) | ingredients | spray liquor | n = 5-7 | n = 5-7 |
| 12-1 | Calypso ® SC 480 | thiacloprid | 0.3 | 0.2 | 0.2 |
| 12-2 | SC480/NMP (0.1) | thiacloprid | 0.3 | 0.16 | 0.24 |
| 12-3 | SC480/NMP (0.3) | thiacloprid | 0.3 | 0.13 | 0.4 |
| 12-4 | SC480/NMP (0.5) | thiacloprid | 0.3 | 0.36 | 0.68 |
| 12-5 | SC480/DMSO (0.1) | thiacloprid | 0.3 | 0 | 0.2 |
| 12-6 | SC480/DMSO (0.3) | thiacloprid | 0.3 | 0 | 0.11 |
| 12-7 | SC480/DMSO (0.5) | thiacloprid | 0.3 | 0.06 | 0.17 |
| 12-8 | SC480/NBP (0.1) | thiacloprid | 0.3 | 2.16 | 2.78 |
| 12-9 | SC480/NBP (0.3) | thiacloprid | 0.3 | 18.25 | 20.96 |
| 12-10 | SC480/NBP (0.5) | thiacloprid | 0.3 | 27.29 | 31.53 |

### Example 13: Penetration Tests with Thiacloprid at Room Temperature in Pear

TABLE 13
Penetration results after 6 hours and after 2 days of example 13

| | Formulation/ | | Thiacloprid | % thiacloprid | % thiacloprid |
|---|---|---|---|---|---|
| | test substance | | concentration | penetration at | penetration at |
| | in the aqueous | | (g/L) in the | RT in pear | RT in pear |
| | spray liquor | Active | aqueous | after 6 h// | after 2 DAT// |
| Example | (% by wt.) | ingredients | spray liquor | n = 5-7 | n = 5-7 |
| 13-1 | Calypso ® SC 480 | thiacloprid | 0.3 | 0.04 | 0.59 |
| 13-2 | SC480/NMP (0.1) | thiacloprid | 0.3 | 0.08 | 0.54 |
| 13-3 | SC480/NMP (0.3) | thiacloprid | 0.3 | 0.51 | 1.25 |
| 13-4 | SC480/NMP (0.5) | thiacloprid | 0.3 | 1.02 | 2.69 |
| 13-5 | SC480/DMSO (0.1) | thiacloprid | 0.3 | 0.14 | 1.33 |
| 13-6 | SC480/DMSO (0.3) | thiacloprid | 0.3 | 0.01 | 0.54 |
| 13-7 | SC480/DMSO (0.5) | thiacloprid | 0.3 | 0 | 0.44 |
| 13-8 | SC480/NBP (0.1) | thiacloprid | 0.3 | 2.16 | 3.52 |
| 13-9 | SC480/NBP (0.3) | thiacloprid | 0.3 | 23.37 | 29.85 |
| 13-10 | SC480/NBP (0.5) | thiacloprid | 0.3 | 34.8 | 44.33 |

### Example 14: Penetration Tests with Thiacloprid at 10° C. In Apple

TABLE 14
Penetration results after 1 day and after 3 days of example 14

| | Formulation/ | | Thiacloprid | % thiacloprid | % thiacloprid |
|---|---|---|---|---|---|
| | test substance | | concentration | penetration at | penetration at |
| | in the aqueous | | (g/L) in the | 10° C. in apple | 10° C. in apple |
| | spray liquor | Active | aqueous | after 1 DAT// | after 3 DAT// |
| Example | (% by wt.) | ingredients | spray liquor | n = 5-7 | n = 5-7 |
| 14-1 | Calypso ® SC 480 | thiacloprid | 0.3 | 0.31 | 0.77 |
| 14-2 | SC480/isophorone (0.1) | thiacloprid | 0.3 | 0.31 | 0.76 |
| 14-3 | SC480/isophorone (0.3) | thiacloprid | 0.3 | 0.14 | 0.44 |
| 14-4 | SC480/isophorone (0.5) | thiacloprid | 0.3 | 0.31 | 0.85 |
| 14-5 | SC480/NBP (0.1) | thiacloprid | 0.3 | 0.83 | 1.34 |
| 14-6 | SC480/NBP (0.3) | thiacloprid | 0.3 | 6.89 | 8.57 |
| 14-7 | SC480/NBP (0.5) | thiacloprid | 0.3 | 18.57 | 20.77 |

### Example 15: Penetration Tests with Thiacloprid at Room Temperature in Apple

TABLE 15
Penetration results after 1 day and after 3 days of example 15

| | Formulation/ | | Thiacloprid | % thiacloprid | % thiacloprid |
|---|---|---|---|---|---|
| | test substance | | concentration | penetration at | penetration at |
| | in the aqueous | | (g/L) in the | RT in apple | RT in apple |
| | spray liquor | Active | aqueous | after 1 DAT// | after 3 DAT// |
| Example | (% by wt.) | ingredients | spray liquor | n = 5-7 | n = 5-7 |
| 15-1 | Calypso ® SC 480 | thiacloprid | 0.3 | 0.46 | 1.48 |
| 15-2 | SC480/isophorone (0.1) | thiacloprid | 0.3 | 0.6 | 1.62 |
| 15-3 | SC480/isophorone (0.3) | thiacloprid | 0.3 | 0.62 | 1.71 |
| 15-4 | SC480/isophorone (0.5) | thiacloprid | 0.3 | 0.33 | 0.87 |
| 15-5 | SC480/NBP (0.1) | thiacloprid | 0.3 | 2.68 | 4.69 |
| 15-6 | SC480/NBP (0.3) | thiacloprid | 0.3 | 8.86 | 11.62 |
| 15-7 | SC480/NBP (0.5) | thiacloprid | 0.3 | 31.27 | 42.15 |

### Example 16: Penetration Tests with Acetamiprid at 1000 in Apple

TABLE 16
Penetration results after 8 hours and after 1 day of example 16

| | Formulation/ | | Acetamiprid | % acetamiprid | % acetamiprid |
|---|---|---|---|---|---|
| | test substance | | concentration | penetration at | penetration at |
| | in the aqueous | | (g/L) in the | 10° C. in apple | 10° C. in apple |
| | spray liquor | Active | aqueous | after 8 h// | after 1 DAT// |
| Example | (% by wt.) | ingredients | spray liquor | n = 5-7 | n = 5-7 |
| 16-1 | Mospilan ® 20 SG | acetamiprid | 0.3 | 0.6 | 13.7 |
| 16-2 | 20 SG/NMP (0.1) | acetamiprid | 0.3 | 0.6 | 14.4 |
| 16-3 | 20 SC/NMP (0.3) | acetamiprid | 0.3 | 1.4 | 18.8 |
| 16-4 | 20 SG/NMP (0.5) | acetamiprid | 0.3 | 3.6 | 24.2 |
| 16-5 | 20 SC/DMSO (0.1) | acetamiprid | 0.3 | 1.6 | 15.9 |
| 16-6 | 20 SC/DMSO (0.3) | acetamiprid | 0.3 | 1.5 | 13.4 |
| 16-7 | 20 SG/DMSO (0.5) | acetamiprid | 0.3 | 2.8 | 22.2 |
| 16-8 | 20 SG/isophorone (0.1) | acetamiprid | 0.3 | 4.2 | 18.1 |
| 16-9 | 20 SG/isophorone (0.3) | acetamiprid | 0.3 | 4.1 | 24.1 |
| 16-10 | 20 SG/isophorone (0.5) | acetamiprid | 0.3 | 4.5 | 16.2 |
| 16-11 | 20 SG/Galaster ® BL97 (0.1) | acetamiprid | 0.3 | 5.4 | 23 |
| 16-12 | 20 SG/Galaster ® BL97 (0.3) | acetamiprid | 0.3 | 5.5 | 19.3 |
| 16-13 | 20 SG/Galaster ® BL97 (0.5) | acetamiprid | 0.3 | 6.6 | 22.8 |
| 16-14 | 20 SG/NBP (0.1) | acetamiprid | 0.3 | 6.9 | 22.8 |
| 16-15 | 20 SG/NBP (0.3) | acetamiprid | 0.3 | 23.9 | 48.1 |
| 16-16 | 20 SG/NBP (0.5) | acetamiprid | 0.3 | 46.1 | 57.7 |

### Example 17: Penetration Tests with Trifluralin at 1000 in Pear

TABLE 17
Penetration results after 1 day and after 3 days of example 17

| | Formulation/ | | Trifluralin | % trifluralin | % trifluralin |
|---|---|---|---|---|---|
| | test substance | | concentration | penetration at | penetration at |
| | in the aqueous | | (g/L) in the | 10° C. in pear | 10° C. in pear |
| | spray liquor | Active | aqueous | after 1 DAT// | after 3 DAT// |
| Example | (% by wt.) | ingredients | spray liquor | n = 5-7 | n = 5-7 |
| 17-1 | EC 540 | trifluralin | 3.5 | 0.53 | 1.31 |
| 17-2 | EC 540/NMP (0.1) | trifluralin | 3.5 | 0.64 | 1.67 |
| 17-3 | EC 540/NMP (0.3) | trifluralin | 3.5 | 0.56 | 1.33 |
| 17-4 | EC 540/NMP (0.5) | trifluralin | 3.5 | 0.81 | 2.06 |
| 17-5 | EC 540/isophorone (0.1) | trifluralin | 3.5 | 0.76 | 1.97 |
| 17-6 | EC 540/isophorone (0.3) | trifluralin | 3.5 | 0.9 | 2.29 |
| 17-7 | EC 540/isophorone (0.5) | trifluralin | 3.5 | 0.79 | 2.13 |
| 17-8 | EC 540/NBP (0.1) | trifluralin | 3.5 | 0.8 | 1.74 |
| 17-9 | EC 540/NBP (0.3) | trifluralin | 3.5 | 2.43 | 4.49 |
| 17-10 | EC 540/NBP (0.5) | trifluralin | 3.5 | 3.66 | 6.19 |

### Example 18: Penetration Tests with Prothioconazole at 10° C. And 20° C. In Pear

Experiments were conducted with the active ingredient prothioconazole with either Genagen® NBP (N-(n-butyl)-2-pyrrolidone) or Emulsogen® EL 360 (castor oil ethoxylate).

The active ingredient was dissolved in acetone/water mixture with a concentration of 2 or 0.75 g/L. The penetration of prothioconazole was measured for pear leaf cuticles. Experiments were conducted with additive systems, firstly with the emulsifier Emulsogen® EL 360 as comparison and secondly with Genagen® NBP as inventive test with an excess of active ingredient (ratio of active ingredient to additive about 2:1).

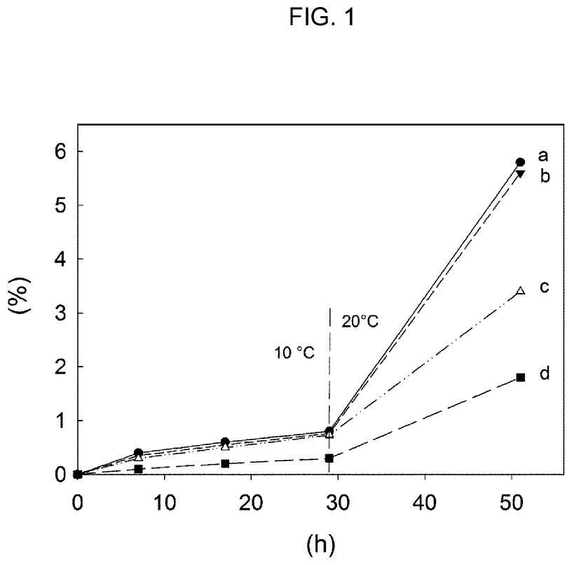

The results of the penetration tests from example 18 are shown in the figure “FIG. 1”. The results reported are averages from the test results from 5-7 treatments.

In FIG. 1:
a prothioconazole (0.75 g/L)+Genagen® NBP (0.4 g/L)
b prothioconazole (2 g/L)+Genagen® NBP (1 g/L)
c prothioconazole (0.75 g/L)+Emulsogen® EL 360 (0.4 g/L)
d prothioconazole (2 g/L)+Emulsogen® EL 360 (1 g/L)

On the x axis of FIG. 1 is plotted the time after application in hours (h).

On the y axis of FIG. 1 is plotted the proportion of active ingredient that has penetrated through the cuticle of the plant, based on the total amount of active ingredient applied to the plant, in percent (%).

Penetration was effected first at 10° C. for about one day, then the temperature was increased to 20° C. with relative air humidity constant at about 60%. The concentration of prothioconazole corresponded to values typical in practice (0.75 g/L or 2 g/L prothioconazole). The water from the application droplets had evaporated completely off the leaf cuticle on the macroscopic scale after no later than one hour. With the emulsifier additive Emulsogen® EL 360, which remains on the cuticle or leaf surface, there is a significant increase in the amount of the active ingredient that penetrates into the plant or a significant increase in the penetration rate by several times when the temperature is increased from 10° C. to 20° C. Genagen® NBP was even more effective with equal use concentrations. This shows that N-(n-butyl)-2-pyrrolidone, even at low use concentrations, can promote penetration sustainably and independently of dissolution properties. This is very favorable for long-term effect or long-term availability, called the “residual efficacy”, of fungicides and insecticides in particular.

### Example 19: Microscopy Studies

### Test Procedure:

The following solutions 1) to 6) were produced:

### Solution 1)

Solution of 1 g of rynaxypyr in one liter of a mixture of acetone and distilled water at a weight ratio of acetone:distilled water of 30:70.

### Solution 2)

Solution of 1 g of rynaxypyr in one liter of a mixture of N-(n-butyl)-2-pyrrolidone and distilled water at a weight ratio of N-(n-butyl)-2-pyrrolidone:distilled water of 30:70.

### Solution 3)

Solution of 1 g of emamectin benzoate in one liter of a mixture of acetone and distilled water at a weight ratio of acetone:distilled water of 30:70.

### Solution 4)

Solution of 1 g of emamectin benzoate in one liter of a mixture of N-(n-butyl)-2-pyrrolidone and distilled water at a weight ratio of N-(n-butyl)-2-pyrrolidone:distilled water of 30:70.

### Solution 5)

Solution of 1 g of abamectin in one liter of a mixture of acetone and distilled water at a weight ratio of acetone:distilled water of 30:70.

### Solution 6)

Solution of 1 g of abamectin in one liter of a mixture of N-(n-butyl)-2-pyrrolidone and distilled water at a weight ratio of N-(n-butyl)-2-pyrrolidone:distilled water of 30:70.

The procedure as described hereinafter was followed with solutions 1) to 6) (see steps A) to C)):
A) 1 μL of the above-described solutions 1) to 6) in each case was applied to silanized glass microscope slides.
B) The solutions were left to stand on the microscope slides at a temperature of 25° C. and 53% relative air humidity over 18 hours, in the course of which drying took place.
C) Thereafter, the microscope slides were assessed and photos were taken at the original edge of the droplets with 400-fold magnification.

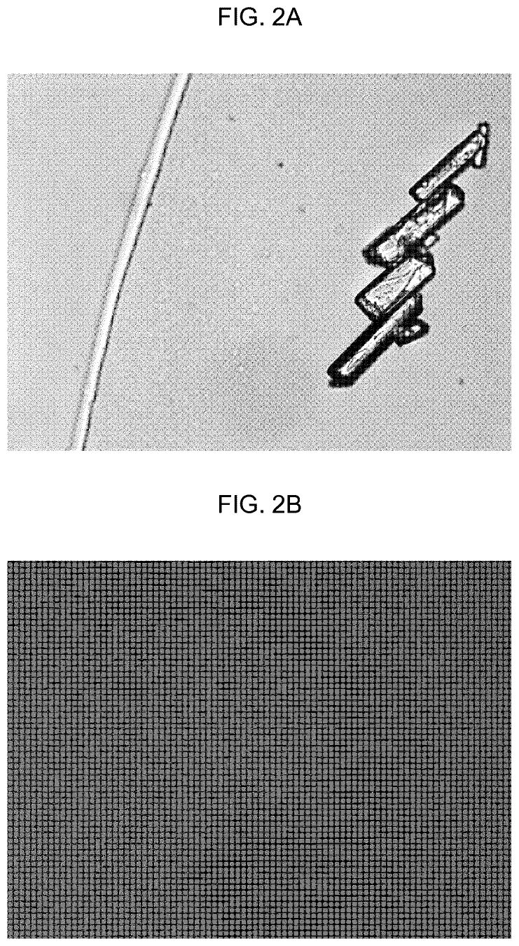

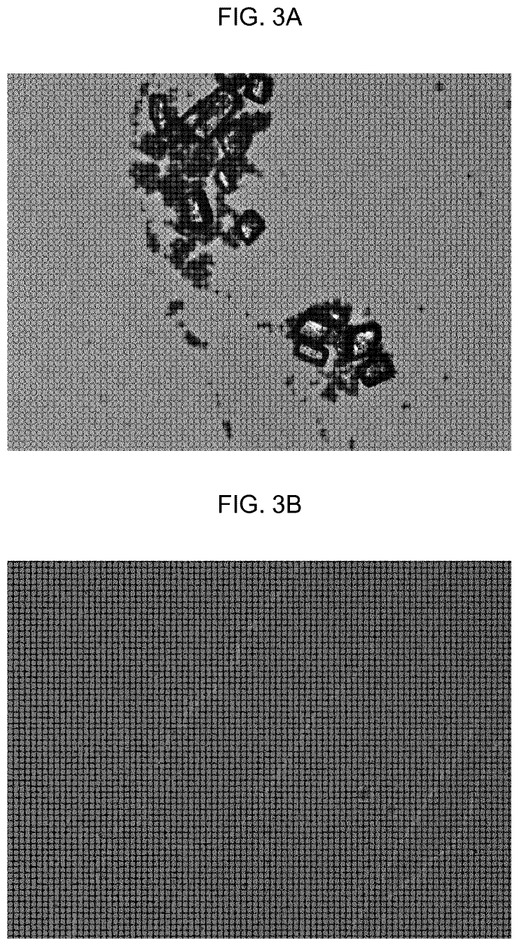

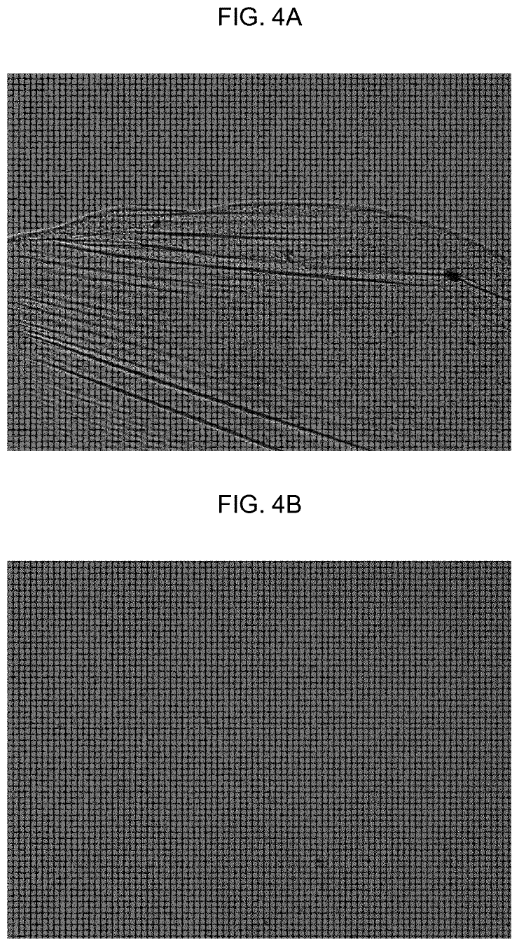

The photos for the active agrochemical ingredient abamectin are shown in FIG. 2A and FIG. 2B, those for the active agrochemical ingredient rynaxapyr in FIG. 3A and FIG. 3B, and those for the active agrochemical ingredient emamectin benzoate in FIG. 4A and FIG. 4B.

It was found that the respective active agrochemical ingredient had crystallized out of the mixture of acetone and distilled water (see FIG. 2A, FIG. 3A and FIG. 4A) and was thus no longer in a biologically available form. In this crystalline form, the respective active agrochemical ingredient cannot penetrate into non-plant harmful organisms.

By contrast, it was found that the respective active agrochemical ingredient, even after 18 hours, had not crystallized out of the mixture of N-(n-butyl)-2-pyrrolidone and distilled water, but was still in dissolved form in N-(n-butyl)-2-pyrrolidone (see FIG. 2B, FIG. 3B and FIG. 4B). In this dissolved form, the respective active agrochemical ingredient can penetrate into non-plant harmful organisms.

### Example 20: Penetration Tests with Abamectin at 10° C. In Pear

TABLE 18
Penetration results after 1 day and after 2 days of example 20

| | Formulation/ | | | % abamectin | % abamectin |
|---|---|---|---|---|---|
| | test substance | | Abamectin | penetration | penetration |
| | in the aqueous | | concentration | (+/−SE) at | (+/−SE) at |
| | spray liquor | | (g/L) in the | 10° C. in pear | 10° C. in pear |
| | (% by wt.) | Active | aqueous | after 1 DAT// | after 2 DAT// |
| Example | at 10° C. | ingredients | spray liquor | n = 5-7 | n = 5-7 |
| 20-1 | EC 18 | abamectin | 0.05 | 0 | 0.18 |
| 20-2 | EC 18/NMP (0.1) | abamectin | 0.05 | 0 | 1.26 |
| 20-3 | EC 18/NMP (0.3) | abamectin | 0.05 | 0 | 0.79 |
| 20-4 | EC 18/NMP (0.5) | abamectin | 0.05 | 0 | 1.21 |
| 20-5 | EC 18/NBP (0.1) | abamectin | 0.05 | 1.4 | 1.52 |
| 20-6 | EC 18/NBP (0.3) | abamectin | 0.05 | 1.2 | 1.64 |
| 20-7 | EC 18/NBP (0.5) | abamectin | 0.05 | 1.3 | 2.32 |

### Example 21: Penetration Tests with Rynaxypyr at 1000 in Pear

TABLE 19
Penetration results after 1 day and after 2 days of example 21

| | Formulation/ | | | % rynaxypyr | % rynaxypyr |
|---|---|---|---|---|---|
| | test substance | | Rynaxypyr | penetration | penetration |
| | in the aqueous | | concentration | (+/−SE) at | (+/−SE) at |
| | spray liquor | | (g/L) in the | 10° C. in pear | 10° C. in pear |
| | (% by wt.) | Active | aqueous | after 6 h// | after 2 DAT// |
| Example | at 10° C. | ingredients | spray liquor | n = 5-7 | n = 5-7 |
| 21-1 | SC 200 | rynaxypyr | 0.1 | 1.17 | 1.36 |
| 21-2 | SC 200/NMP (0.1) | rynaxypyr | 0.1 | 0.98 | 1.1 |
| 21-3 | SC 200/NMP (0.5) | rynaxypyr | 0.1 | 1.06 | 1.25 |
| 21-4 | SC 200/DMSO (0.1) | rynaxypyr | 0.1 | 0.98 | 1.11 |
| 21-5 | SC 200/DMSO (0.5) | rynaxypyr | 0.1 | 1.05 | 1.14 |
| 21-6 | SC 200/Galaster BL 97 (0.1) | rynaxypyr | 0.1 | 1.42 | 1.47 |
| 21-7 | SC 200/Galaster BL 97 (0.5) | rynaxypyr | 0.1 | 1.33 | 1.26 |
| 21-8 | SC 200/isophorone (0.1) | rynaxypyr | 0.1 | 1.1 | 1.15 |
| 21-9 | SC 200/isophorone (0.5) | rynaxypyr | 0.1 | 1.14 | 1.53 |
| 21-10 | SC 200/NBP (0.1) | rynaxypyr | 0.1 | 1.34 | 2.35 |
| 21-11 | SC 200/NBP (0.3) | rynaxypyr | 0.1 | 6.71 | 11.53 |
| 21-12 | SC 200/NBP (0.5) | rynaxypyr | 0.1 | 6.04 | 10.41 |

### Example 22: Penetration Tests with Forchlorfenuron at 10° C. In Pear

TABLE 20
Penetration results after 6 h, 1 day and after 3 days of example 22

| | | | | % | % | % |
|---|---|---|---|---|---|---|
| | Formulation/ | | | forchlorfenuron | forchlorfenuron | forchlorfenuron |
| | test substance | | Forchlorfenuron | penetration | penetration | penetration |
| | in the aqueous | | concentration | (+/− SE) at | (+/− SE) at | (+/− SE) at |
| | spray liquor | | (g/L) in the | 10° C. in pear | 10° C. in pear | 10° C. in pear |
| | (% by wt.) | Active | aqueous | after 6 h// | after 1 DAT// | after 3 DAT// |
| Example | at 10° C. | ingredient | spray liquor | n = 5 − 7 | n = 5 − 7 | n = 5 − 7 |
| 22-1 | Acceptor medium | forchlorfenuron | 0.03 | 2.98 | 8.22 | 12.77 |
| 22-2 | Acceptor medium/NBP (0.01) | forchlorfenuron | 0.03 | 9.67 | 23.2 | 33.79 |
| 22-3 | Acceptor medium/NBP (0.05) | forchlorfenuron | 0.03 | 21 | 40.88 | 53.39 |

The results in table 20 demonstrate that the production of high-efficacy spray liquors with a very low active ingredient content (here 0.03 g/L forchlorfenuron) and a very low content of NBP is possible.

### Example 23: Formulations with Prothioconazole

Formulations with the active ingredient prothioconazole in combination with different additives were produced. The compositions of the individual formulations are apparent from table 21 below. It is found that the active ingredient is in dissolved form in high concentration in all formulations.

TABLE 21

| | Example | Example | Example | Example | Example | Example | Example | Example |
|---|---|---|---|---|---|---|---|---|
| Constituent | 23-1 | 23-2 | 23-3 | 23-4 | 23-5 | 23-6 | 23-7 | 23-8 |
| Prothioconazole (98.5% RW) [g] | | | | | | | 28.88 | 28.88 |
| Prothioconazole (98% RW) [g] | | | 25.26 | 25.26 | 25.26 | | | |
| Prothioconazole (96% RW) [g] | 20.19 | 25.94 | | | | 30.9 | | |
| Genagen NBP (tel-quel) [g] | 65.51 | 15 | 21 | 44.74 | 27.49 | 34.07 | 32.17 | 32.11 |
| Genagen PA (tel-quel) [g] | | 7.5 | | | 14.7 | | 1.5 | |
| MSO (tel-quel) [g] | | | | | | | | 15 |
| Genagen 4296 (tel-quel) [g] | | | | | | | | 1.5 |
| Agsolex 08 (tel-quel) [g] | | | 26.24 | | | 20 | | |
| Solvesso 200 ND (tel-quel) [g] | | 31.56 | | | | | | |
| Rapeseed oil methyl and ethyl | | | 12.5 | | 15 | | | |
| ester (tel-quel) [g] | | | | | | | | |
| Rapeseed oil ethyl ester [g] | | | | | | | 15 | |
| Emulsogen 3510 (tel-quel) [g] | 5 | | | | | | | 5 |
| Synergen 848 (tel-quel) [g] | | | | 10 | 5 | | 5 | |
| Synergen W03 (tel-quel) [g] | | 5 | | | | | | |
| Synergen W09 (tel-quel) [g] | 6.8 | | | | | | | |
| Genapol X 090 (tel-quel) [g] | 2.5 | 4.5 | | | | | | |
| Emulsogen MTP 070 (tel-quel) [g] | | | | 20 | | | | |
| Emulsogen EL 300 (tel-quel) [g] | | 10.5 | | | | | | |
| Emulsogen EL 360 (tel-quel) | | | 15 | | 12.5 | 15 | 17.5 | 17.5 |
| Momentive SAG 1571 (tel-quel) [g] | | | | | 0.05 | 0.03 | 0.01 | 0.01 |
| Total [g] | 100 | 100 | 100 | 100 | 100 | 100 | 100 | 100 |
| Type¹⁾ | 200 EC | 250 EC | 250 EC | 250 EC | 250 EC | 300 EC | 300 DC | 300 DC |

¹⁾ X EC = emulsion concentrate with active ingredient concentration x g/L,
X DC = dispersion concentrate with active ingredient concentration x g/L

Table 21 shows that the use of N-substituted pyrrolidones of the formula I enables the production of highly concentrated active ingredient formulations. The formulations produced were stable and passed the standard FAO tests in respect of emulsifiability and dispersibility. The formulations produced were stable, for example, when stored at 0° C. and 54° C. for two weeks, were redispersible and could be mixed with other substances in the spray liquid without difficulty.

High active ingredient loadings of 300 g/L were achievable in emulsion concentrates and dispersion concentrates.

Table 21 also shows that the N-substituted pyrrolidones of the formula I can be used on their own as solvent (example 23-1) or in combination with other solvents.

The formulations described in table 21 showed a high uptake rate (penetration) that was higher than the standard products on the market.

In standard products on the market, N,N-dimethyldecanamide is frequently used as penetrant. Table 21 shows that this compound can be used in comparatively low concentration as solvent and/or as crystallization inhibitor in combination with the N-substituted pyrrolidones of the formula I used in accordance with the invention as penetrant to give active ingredient formulations having very high penetration.

### Example 24: Formulations with Trinexapac or Abamectin and Acetamiprid

Formulations with the active ingredient trinexapac-ethyl or with abamectin and acetamiprid were produced in combination with different additives. The compositions of the individual formulations are apparent from table 22 below. It is found that the active ingredients are in dissolved form in high concentration in all formulations.

TABLE 22

| | Example | Example | Example | Example |
|---|---|---|---|---|
| Constituent | 24-1 | 24-2 | 24-3 | 24-4 |
| Trinexapac-ethyl (97.1% RW) [g] | 19.44 | 19.51 | 25.84 | |
| Abamectin (95% RW) [g] | | | | 2.1 |
| Acetamiprid (95% RW) [g] | | | | 10.5 |
| Genagen NBP (tel-quel) [g] | 9.69 | 12.49 | 12.94 | 50.4 |
| Hostaphat 1306 (tel-quel) [g] | 24.42 | 26.55 | | |
| Synergen 848 (tel-quel) [g] | 5 | 5 | | |
| Synergen W03 (tel-quel) [g] | | | | 10 |
| Emulsogen MTP 070 (tel-quel) [g] | 29.02 | 31.5 | | |
| Emulsogen ELO 200 (tel-quel) [g] | | | 10 | 7 |
| Synergen SOC (tel-quel) [g] | | | 51.22 | |
| Triethanolamine (tel-quel) [g] | 7.43 | 4.95 | | |
| MSO (tel-quel) [g] | | | | 10 |
| Water (tel-quel) [g] | 5 | | | |
| Total [g] | 100 | 100 | 100 | 100 |
| Type¹⁾ | 200 EW | 200 DC | 250 EC | 120 EC |

¹⁾X EC = emulsion concentrate with active ingredient concentration x g/L; X DC = dispersion concentrate with active ingredient concentration x g/L; X EW = oil-in-water emulsion with active ingredient concentration x g/L

Table 22 shows that the use of N-substituted pyrrolidones of the formula I enables the production of further highly concentrated active ingredient formulations. The formulations produced were stable and passed the standard FAO tests in respect of emulsifiability and dispersibility. The formulations produced were stable, for example, when stored at 0° C. and 54° C. for two weeks, were redispersible and could be mixed with other substances in the spray liquid without difficulty.

The formulations described in table 22 showed a high uptake rate (penetration).

1. The use of one or more N-substituted pyrrolidones of the formula (I) 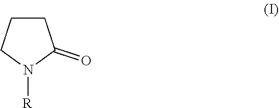
in which
R is a linear or branched, saturated alkyl group having 3 to 6, preferably 3 to 5 and more preferably 4 carbon atoms, where one hydrogen —H in the alkyl group may be replaced by a methoxy group —OCH₃,
and where 1 to 6 hydrogens —H in the pyrrolidone ring may be replaced by methyl —CH₃,
for promotion of the penetration of one or more active agrochemical ingredients into plants or into non-plant harmful organisms.

2. The use as claimed in claim 1, wherein the one or more N-substituted pyrrolidones of the formula (I) are selected from the group consisting of N-(n-butyl)-2-pyrrolidone, N-(isobutyl)-2-pyrrolidone, N-(tert-butyl)-2-pyrrolidone, N-(n-pentyl)-2-pyrrolidone, N-(methyl-substituted butyl)-2-pyrrolidone, ring methyl-substituted N-(propyl)-2-pyrrolidone, ring methyl-substituted N-(butyl)-2-pyrrolidone and N-(methoxypropyl)-2-pyrrolidone.

3. The use as claimed in claim 1 or 2, wherein the N-substituted pyrrolidone of the formula (I) is N-(n-butyl)-2-pyrrolidone.

4. The use as claimed in one or more of claims 1 to 3, wherein the one or more N-substituted pyrrolidones of the formula (I) are used in a crop protection composition comprising
a) 1% to 90% by weight and preferably 5% to 70% by weight of one or more N-substituted pyrrolidones of the formula (I) as claimed in one or more of claims 1 to 3, and
b) 1% to 90% by weight and preferably 2.5% to 70% by weight of one or more active agrochemical ingredients.

5. The use as claimed in one or more of claims 1 to 4, wherein the one or more N-substituted pyrrolidones of the formula (I) are used in a crop protection composition comprising
a) 1% to 50% by weight, preferably 5% to 40% by weight and more preferably 5% to 30% by weight of one or more N-substituted pyrrolidones of the formula (I) as claimed in one or more of claims 1 to 3 and
b) 1% to 90% by weight, preferably 5% to 60% by weight and more preferably 2.5% to 50% by weight of one or more active agrochemical ingredients.

6. The use as claimed in one or more of claims 1 to 3, wherein the one or more N-substituted pyrrolidones of the formula (I) are used in a tankmix additive containing 1% to 90% by weight, preferably 5% to 50% by weight and more preferably 5% to 20% by weight of one or more N-substituted pyrrolidones of the formula (I) as claimed in one or more of claims 1 to 3, and additionally one or more additives and optionally water.

7. The use as claimed in one or more of claims 1 to 6, wherein the one or more N-substituted pyrrolidones of the formula (I) are used in a crop protection composition in the form of an aqueous spray liquor.

8. The use as claimed in claim 7, wherein the one or more N-substituted pyrrolidones of the formula (I) are used in a crop protection composition in the form of an aqueous spray liquor comprising
a) 0.001% to 99% by weight, preferably 0.01% to 50% by weight and more preferably 0.02% to 1% by weight of one or more N-substituted pyrrolidones of the formula (I) as claimed in one or more of claims 1 to 3 and
b) 0.001% to 10% by weight, preferably 0.002% to 5% by weight and more preferably 0.0025% to 3% by weight of one or more active agrochemical ingredients.

9. The use as claimed in one or more of claims 1 to 8, preferably for promotion of penetration into plants, wherein the one or more active agrochemical ingredients are selected from systemic active agrochemical ingredients.

10. The use as claimed in one or more of claims 1 to 9, preferably for promotion of penetration into plants, wherein the one or more active agrochemical ingredients are selected from active agrochemical ingredients having a log P value≤4.5.

11. The use as claimed in one or more of claims 1 to 10, preferably for promotion of penetration into plants, wherein the one or more active agrochemical ingredients are selected from the group consisting of
strobilurin fungicides, preferably azoxystrobin, pyraclostrobin, pycoxystrobin, fluoxastrobin, oryzastrobin, picoxystrobin, trifloxystrobin,
azole fungicides, preferably prothioconazole, tebuconazole, cyproconazole, difeconazole, metconazole, propiconazole, tetraconazole, tricyclazole and
further active ingredients, preferably fluxapyroxad, boscalid, bitertanol, prochloraz, thiophanate, chlorothalonil, dimethomorph, fenpropimorph, spiroxamine, trifluralin, metribuzin, saflufenacil, fenoxaprop-ethyl, acetolachlor, S-metolachlor, pendimethalin, pinoxaden, fluroxypyr, imidacloprid, thiacloprid, thiamethoxam, clothianidin, acetamiprid, emamectin benzoate, lambda-cyhalothrin, pymetrozine, chloantraniliprole, gibberellic acid, benzylaminopyrin, trinexapac-ethyl, etephon, thidiazuron.

12. The use as claimed in claim 11, preferably for promotion of penetration into plants, wherein the one or more active agrochemical ingredients are selected from the group consisting of
strobilurin fungicides, preferably azoxystrobin, pyraclostrobin, fluoxastrobin, picoxystrobin, trifloxystrobin,
azole fungicides, preferably prothioconazole, tebuconazole, cyproconazole, propiconazole, and
further active ingredients, preferably fluxapyroxad, bitertanol, prochloraz, chlorothalonil, fenpropimorph, trifluralin, metribuzin, saflufenacil, fenoxaprop-ethyl, acetolachlor, S-metolachlor, pendimethalin, pinoxaden, fluroxypyr, imidacloprid, thiacloprid, thiamethoxam, clothianidin, acetamiprid, gibberellic acid, benzylaminopyrin.

13. The use as claimed in claim 12, preferably for promotion of penetration into plants, wherein the one or more active agrochemical ingredients are selected from the group consisting of azoxystrobin, pyraclostrobin, fluoxastrobin, trifloxystrobin, prothioconazole, tebuconazole, fluxapyroxad, bitertanol, prochloraz, chlorothalonil, fenpropimorph, trifluralin, metribuzin, saflufenacil, fenoxaprop-ethyl, pendimethalin, imidacloprid, thiacloprid, thiamethoxam, acetamiprid, gibberellic acid, benzylaminopyrin.

14. The use as claimed in one or more of claims 1 to 8, preferably for promotion of penetration into non-plant harmful organisms, wherein the one or more active agrochemical ingredients are selected from the group consisting of
insecticides from the pyrethroid family, preferably cypermethrin, deltamethrin, permethrin, cyfluthrin, bifenthrin, lambda-cyhalothrin, gamma-cyhalothrin;
organophosphate insecticides, preferably chlorpyrifos;
benzoylurea insecticides, preferably diflubenzuron, lufenuron;
other insecticides, preferably abamectin, emamectin benzoate, flubendiamide, fipronil, rynaxypyr, spiromesifen, spirodiclofen, fipronil, indoxacarb;
amide fungicides, preferably prochloraz;
other fungicides, preferably trifloxystrobin, mancozeb, chlorothalonil;
herbicides, preferably acetochlor, propanil, glufosinate.

15. The use as claimed in one or more of claims 1 to 10, preferably for promotion of penetration into non-plant harmful organisms, wherein the one or more active agrochemical ingredients are selected from the group consisting of fenpicoxamid, bixafen, isopyrazam, fluopyram, penthiopyrad and abamectin.

16. A method of promoting the penetration of active agrochemical ingredients into plants or into non-plant harmful organisms, wherein one or more active agrochemical ingredients are applied to the plants simultaneously or sequentially together with one or more N-substituted pyrrolidones of the formula (I) as claimed in one or more of claims 1 to 3.

17. The use as claimed in one or more of claims 1 to 15 or method as claimed in claim 16, wherein the penetration of the one or more active agrochemical ingredients into the plants or into the non-plant harmful organisms, and preferably into the plants, takes place at least at times at a temperature of not more than 25° C., preferably at least at times at a temperature of not more than 20° C., more preferably at least at times at a temperature of not more than 15° C. and especially preferably at least at times at a temperature of not more than 10° C.

18. A crop protection composition comprising
a) 1% to 90% by weight and preferably 5% to 70% by weight of one or more N-substituted pyrrolidones of the formula (I) as claimed in one or more of claims 1 to 3, and
b) 1% to 90% by weight and preferably 2.5% to 70% by weight of one or more active agrochemical ingredients, preferably as claimed in one or more of claims 9 to 15.

19. The crop protection composition as claimed in claim 18, comprising
1% to 50% by weight, preferably 5% to 40% by weight and more preferably 5% to 30% by weight of component a), and
1% to 90% by weight, preferably 5% to 60% by weight and more preferably 2.5% to 50% by weight of component b), preferably as claimed in one or more of claims 9 to 15.

20. A crop protection composition in the form of an aqueous spray liquor comprising
a) 0.001% to 99% by weight, preferably 0.01% to 50% by weight and more preferably 0.02% to 1% by weight of one or more N-substituted pyrrolidones of the formula (I) as claimed in one or more of claims 1 to 3 and
b) 0.001% to 10% by weight, preferably 0.002% to 5% by weight and more preferably 0.0025% to 3% by weight of one or more active agrochemical ingredients, preferably as claimed in one or more of claims 9 to 15.

21. The crop protection composition as claimed in claim 20, wherein the content of component b) is less than 0.05 g/L, preferably 0.01 to 0.03 g/L, and the content of component A) is especially less than 0.1% by weight, more preferably 0.01% to 0.05% by weight, based on the total amount of the spray liquor.

22. The crop protection composition as claimed in any of claims 18 to 21, wherein component b) is selected from the group consisting of fungicides, bactericides, insecticides, acaricides, nematicides, herbicides, plant growth regulators, plant nutrients, repellents, molluscicides and/or rodenticides.

23. The crop protection composition as claimed in claim 22, wherein component b) is selected from the group consisting of herbicides, fungicides, insecticides, nematicides and/or plant growth regulators.
